(19) United States
(12) Patent Application Publication
(10) Pub. No.: US 2013/0339074 A1
(43) Pub. Date: Dec. 19, 2013

(54) SYSTEM OF EVALUATING WORK CHARACTERISTICS AND PROVIDING WORKSPACE DESIGN SUGGESTIONS

(71) Applicants: Gabor Nagy, Sausalito, CA (US); Jay L. Brand, Glenn, MI (US); David A. Fik, Hudsonville, MI (US); Sally J. Augustin, Holland, MI (US); Haijie Ding, Shanghai (CN); David S. Meyer, Hudsonville, MI (US); Rick A. Perkins, Holland, MI (US)

(72) Inventors: Gabor Nagy, Sausalito, CA (US); Jay L. Brand, Glenn, MI (US); David A. Fik, Hudsonville, MI (US); Sally J. Augustin, Holland, MI (US); Haijie Ding, Shanghai (CN); David S. Meyer, Hudsonville, MI (US); Rick A. Perkins, Holland, MI (US)

(73) Assignee: HAWORTH, INC., Holland, MI (US)

(21) Appl. No.: 14/003,611

(22) PCT Filed: Mar. 7, 2012
(86) PCT No.: PCT/US12/28029

§ 371 Date: Sep. 6, 2013

Related U.S. Application Data
(60) Provisional application No. 61/464,610, filed on Mar. 7, 2011.

(51) Int. Cl. G06Q 10/06

(52) U.S. Cl. CPC G06Q 10/0631
USPC 705/7.12

(57) ABSTRACT

A computer-based system and method are provided for assessing extrinsic and intrinsic work characteristics of people, and storing such data for evaluation of user pre-defined groups' Workstyles and using the Workstyles and additional survey data to develop design implications for the workspace in which such groups will work in an office environment. The Workstyles encompass multiple types of Workstyles which describe characteristics of where and how individual employees work, how much control they have over their work, and what kind of work they do. The design implications provide design guidance, which are expressed in relative terms and provide suggested guidance as to the development of the individual workspaces (workstations) for a group but do not dictate the specific design thereof.

### FIELD OF THE INVENTION

The invention relates to a computer-based evaluation tool and a method thereof for assessing work characteristics of individuals to identify their workstyles and the design implications of such workstyles.

### BACKGROUND OF THE INVENTION

In office environments, it is conventionally known to outfit large office areas with different types of office furniture products such as space-dividing wall panels, work surfaces, storage and other office furniture components to define multiple individual work stations. In the following description, the workplace is the whole office, including individual workspaces and common areas (such as meeting rooms). The workspace refers to individual work areas, i.e., a desk and a chair on a minimum, where an individual works, plus storage furniture as need. The workspace can be a cubicle, an open work station, a private office, etc.

The specific configuration of the work stations or workspaces can be designed with a variety of office furniture components. For many businesses requiring multiple work stations, a business may work with intermediary design consultants, architects, office furniture manufacturers or dealers and the like in order to develop a specific floor plan for the office space being developed.

When outfitting office spaces or workspaces with these office furniture components, efforts have been made to attempt to identify the different requirements of different groups which might form a business, and then design the work stations or workspaces to accommodate the unique requirements of the business groups. The workspaces can have different characteristics and design configurations depending upon the needs of the different business groups, or even certain subgroups within them. However, many prior methods of attempting to design work spaces possess deficiencies in identifying the work characteristics of the various business groups or subgroups within them and may not adequately take into account different work characteristics of these groups.

Some companies have attempted to address such deficiencies by attempting to classify workers as having different workstyles and then attempting to develop floor plans which take into account such workstyles.

In one such system, the system attempts to evaluate a workplace and has developed five different workstyles, although these workstyles are based solely upon the mobility of the people, or in other words, where these people work. This limits the usefulness of such system.

Another system uses six different workstyles, although these assessments are primarily based upon the individual storage needs which represent what people store at their work station and how they process information. The value of this system is limited to developing storage needs.

Another system uses a Myers Briggs personality assessment to link individual psychological profiles with different workstyles. However, this personality-based system does not take into account extrinsic work characteristics encountered during one's workday, such as characteristics that are required from someone by the nature of his or her work (e.g., a consultant being on the phone a lot).

Another system attempts to identify 16 different workstyles which are based primarily upon generational differences which are then used to generate four concrete design sketches.

Still further, another system attempts to identify differences in workstyles which workstyles are evaluated by differences in people's mobility and their interaction with each other, although this still provides an incomplete picture of the extrinsic, as well as the intrinsic work characteristics of an employee.

Most importantly, one common characteristic of said systems is that they identify a certain number of workstyle categories (5, 6, or even 16), and provide a generalized “solution” for each in terms of workspace design. The problem with such generalization is that it completely ignores the overall context, i.e., differences among companies, industries, and even countries. Said systems assume that if a group of worker falls into one particular workstyle category, they require the same “solution” for their physical workplace, regardless of the industry they work in, or organizational or national cultures. It does not take much to assume that a banker in Tokyo would most likely have or need a very different work place than his/her counterpart would have or need in Oklahoma City. One aspect might be size of office. Also, an administrative employee at a law firm most likely would have a very different workspace than his/her counterpart at a manufacturing firm. One aspect might be the level of privacy they need for confidential documents.

### SUMMARY OF THE INVENTION

It is an object of the invention to provide an inventive evaluation system and related method, which uses a unique set of Workstyles, and evaluates both extrinsic and intrinsic work characteristics of people to identify various work characteristics which in turn identify the particular Workstyle of each individual. Further, this system and method evaluates other extrinsic and intrinsic characteristics not typically associated with any particular Workstyle, but which provide additional guidance in determining preferred design features of an office environment. This, in turn defines the context where each individual collectively work in, and will provide a much refined suggestion for design guidance than were such context completely ignored as described above.

This system of the invention therefore identifies individual extrinsic and intrinsic characteristics of the work each individual does, and then evaluates this information at a group level for a predefined subgroup of employees of a business operation to determine the dominant Workstyle or Workstyles exhibited by each group. This information is further used to develop design implications based upon the Workstyles and the individual work characteristics of the people which form one of the business groups or subgroups.

It is logical to assume that each business group (e.g., a department) has their own unique dominant workstyle; however, sometimes further analyses are needed to find patterns of work characteristics within each business group that characterize sub-groups. These sub-groups can be pre-defined in the system by several so-called standard demographics (age, gender, job level, job type, and the like). These sub-groups are either pre-defined before running an analysis, or can be narrowed down after obtaining more than one dominant workstyle for a certain business group. In such case, a user can see whether there is a certain pattern in the differences between these two dominant workstyles that can be linked by demographic differences (e.g. managers vs. employees).

The preferred system of the invention preferably does not seek to dictate precise work station layouts and design configurations in absolute terms (such as 60 cubic feet of storage, or 65 inches tall partitions), but rather, provides more general design implications in relative terms for the different groups (such as less storage or higher partitions), which design implications can then be considered in the work environment context of an organization when the specific furniture and work station layouts are developed. So if the current standard is 80 cubic feet storage and 50 inch tall partitions for a particular business group or subgroup, and the result of the workstyle survey is that they need less storage and higher partitions, then the designer will know that they will need less than 80 cubic feet of storage, but higher than 50 inches of partitions, and can provide an optimum solution based on several other factors, such as furniture modules, new design guidelines, and/or customer preference.

The system of the invention uses a computer-based survey tool to evaluate extrinsic and intrinsic characteristics of the Workstyles of the individuals who form a business operation. The extrinsic work characteristics are based upon characteristics of a job being performed by an individual. These extrinsic characteristics are expected as part of the job type and would be consistent for each job type. The intrinsic characteristics relate to an individual's personal factors and specifically, relate to how this person does his or her job. These do not represent individual personality types but more generally relate to the intrinsic needs of the individual in performing their job. To provide an example, a consultant might be required to spend a considerable amount of time with clients interacting (extrinsic characteristics of his/her job), but she/he might prefer to work solo, with minimum social interaction with people (intrinsic characteristics or personal factors). It would be a mistake to ignore one or the other when defining workstyles and design implications.

The preferred framework for the different Workstyles comprises four (4) domains or dimensions as described in further detail hereinafter. The system identifies the workstyle domains for each individual by survey results to thereby identify a single Workstyle associated with each individual. Using the four domains, each with 2 opposing poles, as described in further detail hereinafter, the possible number of Workstyles in the system is 16. However, some of there Workstyles are combined into same groups, thus preferably having only 11 (8 plus 3) Workstyles.

Once the various Workstyles are identified for the individuals taking the surveys, these Workstyles are then evaluated by the computer-based system at a group level to determine the composition of the Workstyles present in each of the different business groups, resulting in one or more dominant Workstyles that are most common for a particular group.

As noted above, the initial survey contains questions which identify both the individual Workstyles through Workstyle questions, and also includes secondary questions which are directed towards additional supplementary work characteristics. This combination of the Workstyle characteristics and work characteristics then are evaluated to identify a plurality of design implications relative to various features of the individuals' workspace. The system preferably uses eight different categories of design implications which relate to a plurality of work space features. Each category may comprise a sub-set or plurality of design implications which can relate to various workspace characteristics and to characteristics of the office components used in association with such workspace. A category by itself may define only a single workspace implication.

To generate the design implications, the system performs calculations using the survey data to generate specific design implications. The system also weights the importance of these implications depending upon the number of individuals in a group to which a particular feature may be important or not. In this regard, the system provides an indicator of the degree of confidence associated with the design implications, i.e., if such design characteristic is implemented, would it satisfy almost all members of a group, a majority of them, or only half of them. This so-called confidence level is shown with graphical representation in the system (for example bold for highest confidence—almost all members satisfied, or plain for high confidence—the majority of members satisfied, etc.) This feature is highly useful in the system, because offices are almost never designed to individual differences (except for very small ones with a few personnel). Organizations like to have a few design standards that they can “deploy” across the entire organization, based on group level, so in case of personnel turnover, the open workspaces can be reused within the same group, since workstyles were addressed on the group level.

The system of the invention allows for the generation of multiple reports providing an ability to update the data associated with the Workstyles and design implications.

Therefore, when designing the individual workspaces in an office or work area or work place, the design implications serve as non-binding guidance to help in the design of these spaces. Preferably, the design implications are presented for each of the Departments or groups making up an organization, since the design implications typically will vary between groups because each group may have different work characteristics depending upon the work being performed. By considering the unique design implications for each group, the workspaces can be uniquely designed for each group to best accomplish the work being performed by that group.

In one aspect, the system of the invention includes a computer-based tool for recommending design implications for workspaces of a plurality of individual employees working within an organization. The tool may include at least one of a memory, a user interface, a processor, and a design implications interface. The memory stores a plurality of questions for assessing extrinsic and intrinsic work characteristics of each of the individual employees within the organization. The user interface may be in communication with the memory, and may implement a survey for each of the individual employees. The user interface may selectively provide at least one of the stored questions from memory to each of the individual employees, and may obtain answers from each of the individual employees in order to output information relating to the extrinsic and intrinsic work characteristics of each of the individual employees. The processor may be in communication with the user interface, and may be programmed to perform a variety of functions. For example, the processor may receive the information from the user interface, define at least one group formed of a subset of the individual employees working within the organization, and evaluate the information relating to extrinsic and intrinsic work characteristics for each of the at least one group. The processor may also be programmed to output one or more design implications for the workspace based on the extrinsic and intrinsic work characteristics for each of the at least one group of individual employees. The design implications interface may be in communication with the processor, and may receive the one or more design implications from the processor. The design implications interface may also display one or more design implications.

Other objects and purposes of the invention, and variations thereof, will be apparent upon reading the following specification and inspecting the accompanying drawings.

### BRIEF DESCRIPTION OF THE DRAWINGS

FIG. 1 diagrammatically illustrates the computer-based system and method of the invention on a simplified framework including the collection of work characteristics data, personal factors data and demographic data, the output of Workstyles as Output Level I and the physical workspace implications as Output Level II. A preferable future module is also represented here (Current Spatial Situation) that investigates concrete physical characteristics of a given workplace, so that more precise design implications can then be provided, and also outlining the gaps (delta) therebetween.

FIG. 2 diagrammatically represents one scenario for use of the inventive system in association with a business or organization comprised of multiple departments. As illustrated here, one department or group can have one or more workstyles, and one or more workstyles can yield to similar workstation configuration types.

FIG. 3 illustrates the Workstyle model that is preferably used with the inventive system.

FIG. 4A is a table illustrating the preferably four domains of the Workstyles framework preferably comprising People, Place, Knowledge and Control domains, wherein each domain has two poles indicated by + or −, and are preferably named (such as Interactive and Independent), as well as abbreviated (such as P+ and P−).

FIG. 4B illustrates an alternative but also preferable set of four workstyle domains that corresponds to those illustrated on FIG. 4, but has different naming: Location (the equivalent of Place), Interaction (the equivalent of People), Autonomy (the equivalent of Control) and Knowledge (same category). This alternative, but also preferable illustration uses a percentage scale, rather than a bipolar scale (that of FIG. 4—plus or minus poles) where the sliding bar (or similar graphical illustration) represents percentage of population falling into given categories. The two end poles are similar to those of FIG. 4, but are alternatively named Fixed vs. Mobile on the Location dimension, Face-to-face vs. Solo on the Interaction dimension (corresponding to the Interactive and Independent categories, respectively on FIG. 4), Low and High on the Autonomy dimension (corresponding to External and Internal control, respectively, on FIG. 4), and Strategic vs. Tactical on the Knowledge dimension (corresponding to the Conceptual and Concrete categories, respectively on FIG. 4).

FIG. 4C illustrates a possible combination of these 4 workstyle dimensions, along with an explanation of each.

FIG. 5 illustrates an example of a design of mobile workspaces that results from an evaluation of the Place domain.

FIG. 6 illustrates an example of a workspace configuration for fixed (assigned) workspaces as determined by analyzing the People domain.

FIG. 7 illustrates workspace configuration further modified when taking into account the Knowledge and Control domains.

FIG. 8 shows the eight plus three Workstyles defined by the four domains and the opposite poles of each domain. Workstyles can also be “coded” with the abbreviation of these four domains, such as P+L+K−C− would be an abbreviation for Interactive, Fixed, Concrete, External Control workstyle (as depicted on FIG. 4) or Face-to-face, Fixed, Tactical, Low Autonomy (as depicted on FIG. 4a). Any of these 3 descriptions could describe a certain workstyle, however testing shows that the set of domains depicted on FIG. 4a may perhaps be easier to understand.

FIG. 9 is a complete table showing all possible combinations of the domains and poles wherein the mobile pole of the Place domain is consolidated into the three possible mobile Workstyles of FIG. 8.

FIG. 10 diagrammatically represents eight main categories of preferred workspace design implications which are determined by consideration of the eight plus three Workstyles and additional supplementary data collected during an initial survey stage.

FIG. 11A illustrates a table of the preferred design implications and the available options for these design implications.

FIG. 11B illustrates one example of the design implications calculated for a particular group. The legend below the table shows the confidence levels of each design implication.

FIG. 11C is a table showing the confidence levels in terms of percentages.

FIG. 12 diagrammatically represents a randomized survey consisting of 9 to 12 questions that are used to identify the Workstyles as well as secondary information which are considered together to identify the design implications for an individual and each group of an organization. The survey questions are randomized (to reduce errata from “survey fatigue”) in those chunks represented by bullet points on FIG. 12. Connectors refer to “branching,” meaning that for example Q8 and Q9 questions may be displayed if respondent answers to Q7 (the gateway question) in a certain way (e.g. selecting the last option).

FIG. 13 illustrates one method of a computer-based slider used for data collection. As more and more data accumulates in the system, the dividing point (between the two poles of plus or minus) is automatically adjusted by the system to follow the data points empirically, while the sliding bar remains in the middle for the user interface before users make their selection (i.e., slide the bar).

FIG. 14A illustrates questions Q1-6 of the survey with the data preferably being collected for each question.

FIG. 14B illustrates the additional questions of the survey.

FIG. 14C shows a startup screen of an online survey tool where users can select the survey language (English, German, French, Russian or any language that is uploaded or will be uploaded as per demand into the system).

FIG. 14D shows a startup screen of an online survey tool.

FIG. 14E shows the introductory screen to this survey before the first question is shown.

FIG. 14F shows a first randomly selected question screen of the survey tool.

FIG. 14G shows a second randomly selected question screen.

FIG. 14H shows a third randomly selected question screen.

FIG. 14I shows a fourth randomly selected question screen.

FIG. 15 diagrammatically represents how the survey data is used to identify any of the eight plus three Workstyles and design implications directly associated with such Workstyles, as well as additional design implications.

FIG. 16 is a table illustrating the eight plus 3 Workstyles and certain design implications which are Workstyle directed.

FIGS. 17-28 are computer-based screen shots showing various steps of the computer-based system performing the method of the invention.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

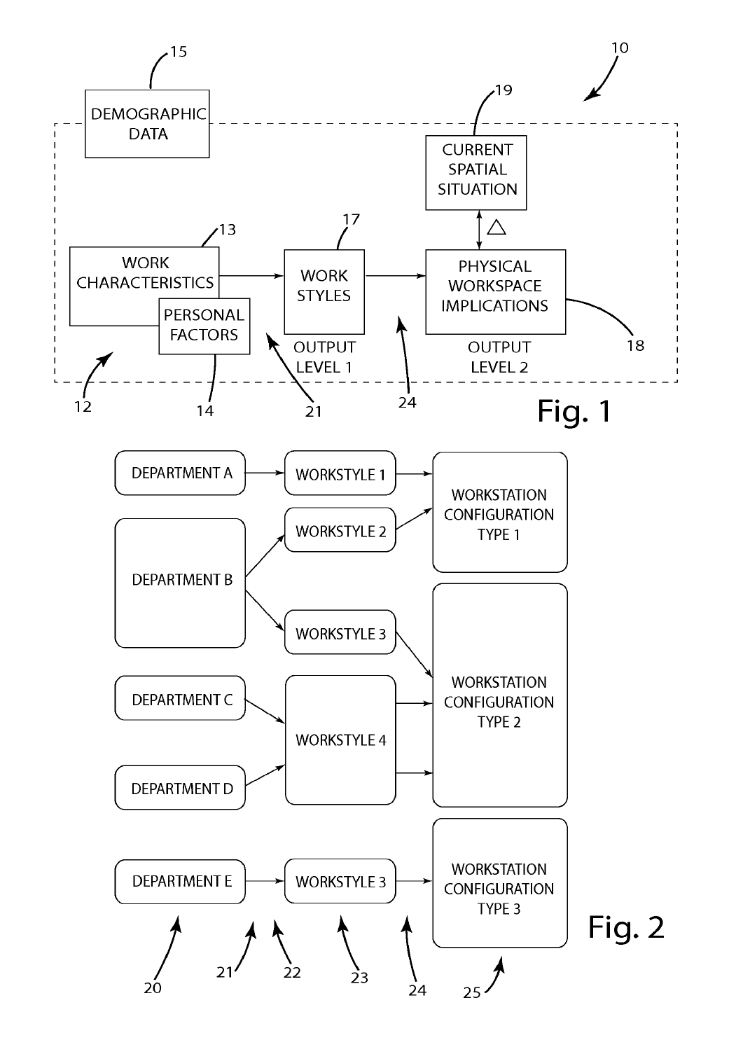

Referring to FIG. 1, the system and method of the invention relates to a computer-based process for evaluating the Workstyles of the individuals which make up an organization such as a business or other similar operation. When designing workspaces for these individuals, it is found that many organizations are formed of separate groups of workers performing different jobs. These separate groups usually fall into separate departments at organizations, but sometimes, especially in case of large departments they might comprise several sub-groups. As such, the design needs for the workspaces used by the different groups can vary depending upon work characteristics and other personal factors. To provide design guidance for a designer of these workspaces, the computer-based evaluation system 10 of the invention is diagrammatically shown in FIG. 1. The system 10 comprises computer-based components, such as collecting and processing data. The system 10 is able to identify the unique work characteristics and personal factors, and translate this data to identify the different Workstyles of the groups, and in turn translate the data into various design implications for the workspaces of each group. These design implications are then considered by a designer when designing the physical layout of a workplace including the workspaces thereof.

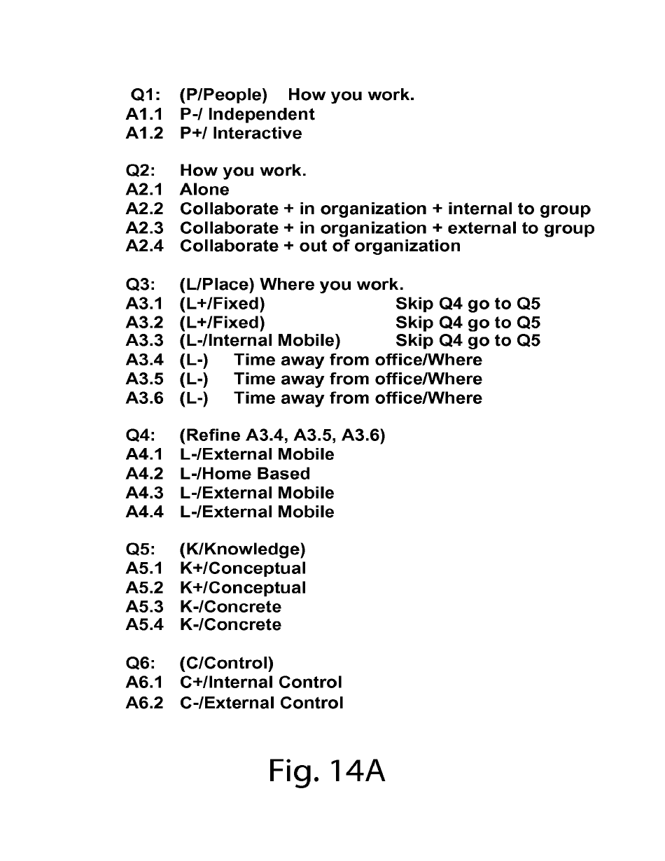

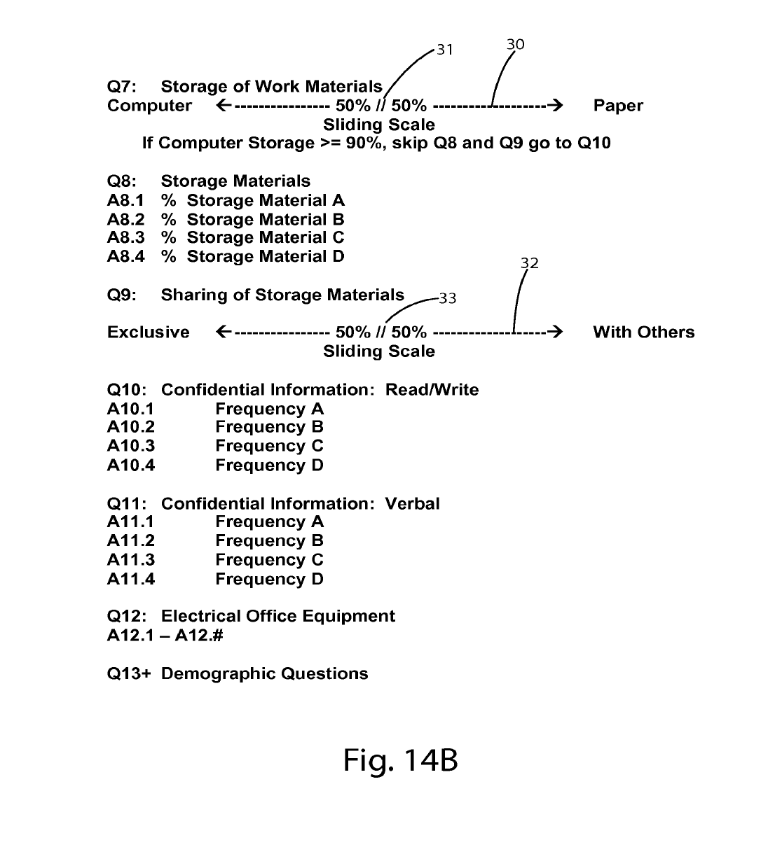

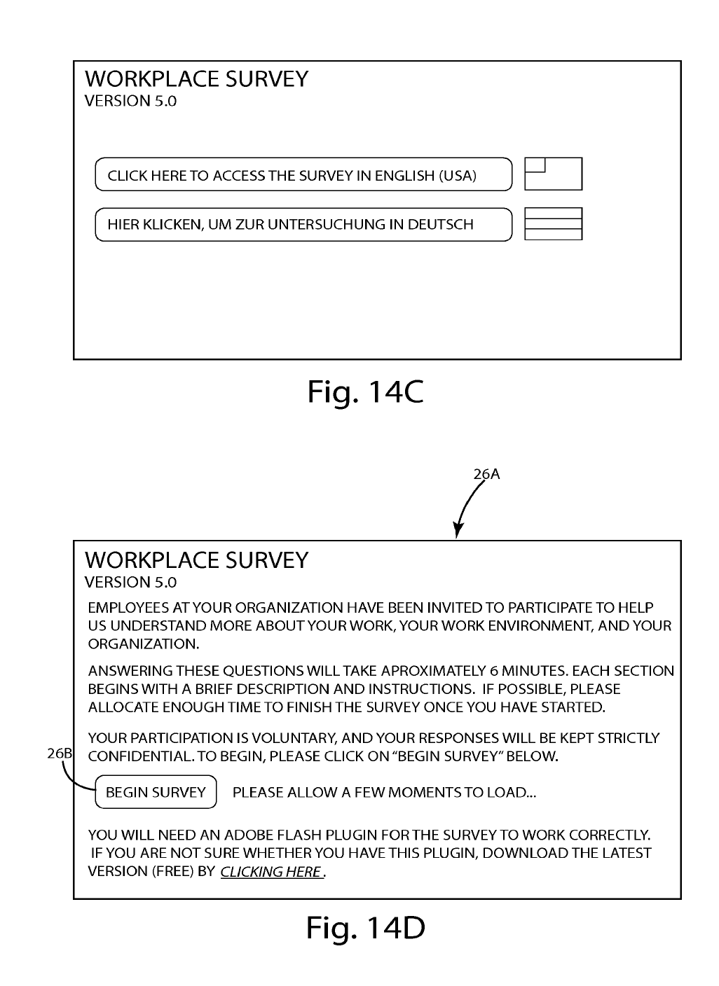

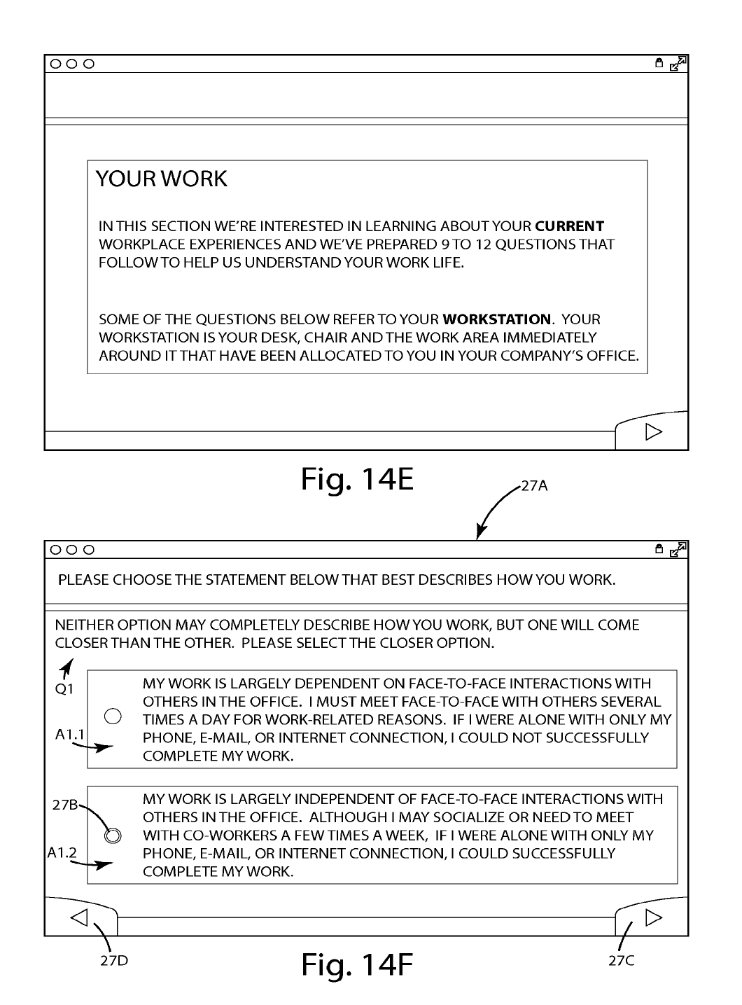

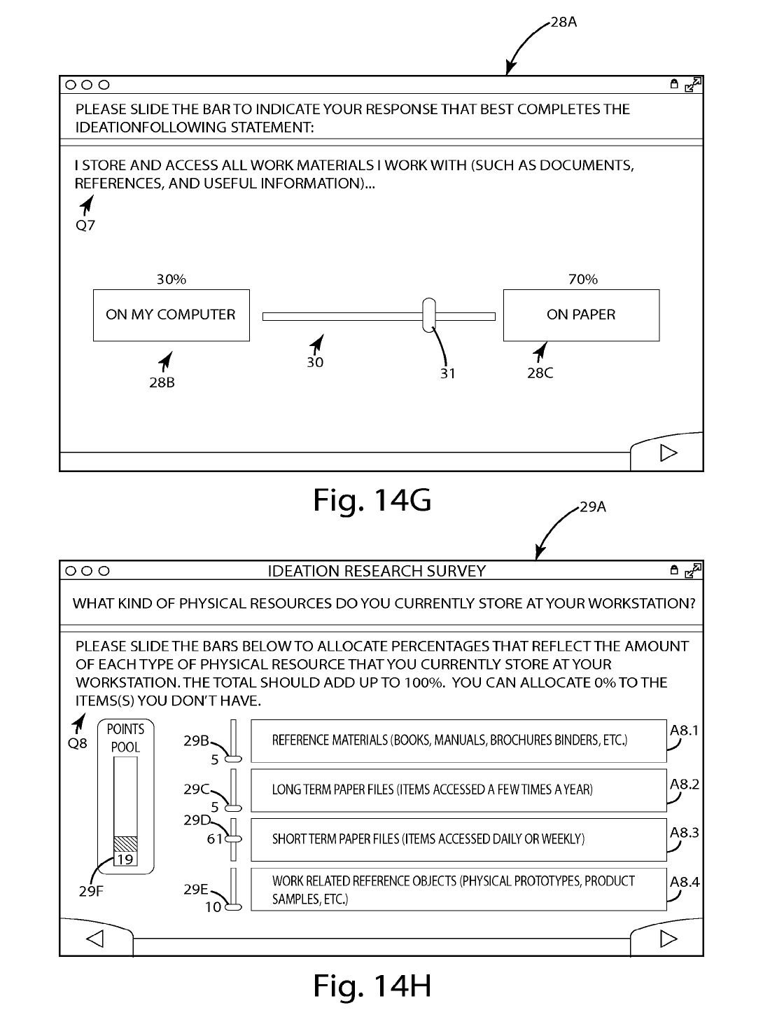

In more detail, the system 10 determines the Workstyles by evaluating the work characteristics of individuals and then providing design guidance as to the workspaces in which the individuals of various groups of the organization will function. The work characteristics of the individuals that form a group is first collected preferably via online surveys administered to each individual in said group; the individual-level data is then tallied to the group level, and one or more dominant Workstyles are identified for the group. Based on the supporting questions in the survey, for the same group, design implications are then reported out, taking into account their Workstyles, as well as auxiliary data from supportive questions (FIGS. 14A,B). This provides alignment between the employees' work tasks and activities and the design of their workspaces. The intent of the system and method of the invention is not to provide concrete design criteria in absolute terms or to dictate predefined workstation constructions, but instead the intent is to provide design guidance for development of the workspaces in relative terms. This guidance is provided by the design implications identified through use of the inventive system.

This computer-based system of the invention is usable by multiple parties involved in designing and outfitting workspaces for businesses and other operations. For example, the system 10 may be used by an office furniture manufacturer when consulting directly with customers and clients, or when consulting with intermediate design groups, such as architects and designers, sales representatives and furniture dealers who work between the office furniture manufacturer and the customer.

Generally with respect to the Workstyles, the Workstyles of the inventive system are evaluated and assessed based upon the work characteristics encountered by the individuals, which are the extrinsic expectations directly resulting from an individual's job or work requirements. These Workstyles also take into account personal factors for the individuals, which are the intrinsic behavioral preferences of the individual being evaluated. The invention uses a unique set of Workstyles which define a comprehensive assessment of an individual since they take into account extrinsic work characteristics plus intrinsic personal factors.

The system of the invention is generally designated as 10 in FIG. 1 and preferably is a computer-based system and even more preferably, is an online or web-based system which is operated on appropriate hardware. In an online or web-based application, the hardware may be a server accessible through the internet, or an extranet or other similar computer-based hardware. If desirable, the system could be operated on stand-alone personal computers. The system 10 of the invention is not intended to be limited by the particular computer-based hardware on which the system and the software application defining such system are operated. The system 10 also works on any device, such as a handheld phone or smartphone, PDA or tablet/iPad that can either access the World Wide Web, a particular intranet, or has the capability to run software applications that are not necessarily connected to any network.

The system 10 includes a data collection feature through which a survey is conducted of preferably each individual or worker of an organization. The survey preferably is performed through a computer based device such as remote computer terminals that access the system 10 through an internet connections or the like. Typically, when an organization is being evaluated, each employee or worker is asked to access the system 10 (preferably via a weblink) and perform their own personal survey described below. This generates input data which is stored by the system 10 for subsequent processing during or after workers have completed their surveys. This represents a first data collection stage or step. This data collection may also be described as a survey step.

The input data 12 essentially comprises data relating to the extrinsic work characteristics 13 encountered by a worker in performing their work, and relating to the individual's personal factors (i.e., intrinsic work characteristics) 14. Additionally, the data input preferably also includes demographic data 15 which is collected to assist in the evaluation of the categorization of Workstyles and design implications.

When performing or operating the system of the invention on behalf of a particular client, one exemplary scenario occurs when a client (not necessarily a furniture-buying customer), such as a business operation or other similar operation has a large office space in which numerous employees will be working. The term organization can refer to any collection of individuals working in a common space, and may include large and small businesses, non-profit organizations, educational organizations, and the like. Their common characteristics is that they all perform so-called “knowledge-work,” in other words “white-collar” (or office-) work, versus performing truly “physical work” (“blue collar”), such as a factory worker.

Typically, such organizations are formed of different departments or groups wherein the term group herein refers to any subgrouping of employees which may be dictated by formal departments, informal working groups, or any other subdivision of groups defined by the system, such as based on demographic data (job level, job type, etc). Hence, the term group is not intended to be limiting other than to indicate a subgroup of employees or individuals wherein multiple such groups form a particular operation. A group can be any number of any employees of an organization sharing one or more characteristics. Such characteristic can be, but not limited to, being part of the same department, having the same job level, or job type and the like. Further, the term group is not restricted to any particular number of individuals since a group may even be as small as one individual operating with their own particular work requirements. Typically, the specific groups forming an operation already exist and are defined by the particular operations of the business. Hence, the system of the invention is able to identify these preexisting groups as part of the evaluation process.

The system 10 of the invention thereby collects the work characteristics 13 and personal factors 14 through a survey module or stage which surveys each individual to determine their work characteristics 13 and personal factors 14. This is described in further detail hereinafter. The computer-based system 10 then processes or evaluates all of the survey data collected for all of the individuals, and for each individual, identifies the particular Workstyle 17 for all of the organization's workers which is represented in FIG. 1 as Output Level I.

Hence, it can be said that each individual has a particular Workstyle. More than one individual can share the same Workstyle category. However, when designing numerous workspaces within a large work area, it likely is impractical to attempt to individually tailor the individual workspaces based upon each person's particular Workstyle. This becomes difficult to manage in a large organization. Moreover, it is customary to provide anonymity to survey participants in order to obtain more honest results, and this would not be possible if the survey results were evaluated on the individual basis. Therefore, it is a preferred feature of the inventive system 10 to then take the Workstyles of the individuals and evaluate these Workstyles 17 on a group level (by summing up individual results within a group) and also determine the physical workspace or design implications 18 of each of the individual groups forming an operation. By summing up the individual data into group level data, the design guidance is more manageable.

As indicated above, the group level may be any subgrouping of individuals, whether based upon a formal hierarchy of a business, or based upon more informal group interactions or particular clusters of individuals. Whatever the grouping is, it is always defined (and can be always modified) by the user of the invention. Further, the groupings may be comprised of primary groups, such as Departments, which in turn are each formed of one or more subgroups of individuals. The level of the groups being considered as part of the system 10 can vary depending upon the specific needs of a particular customer or client, but 1-3 levels are usually used for analyses of typical organizations. Larger, more complex organizations might need more levels.

The physical workspace design implications are designated as Output level II so that the system 10 provides an additional level of output information for use in providing design guidance when outfitting workspaces. The system 10 of the invention is primarily directed to steps of initial data collection, and subsequently identifying the Workstyles 17 and generating physical workspace implications 18 in Output Levels I and II. However, the system 10 also may identify Current Spatial Information 19 as seen in FIG. 1, which assesses and identifies the current spatial configuration of the workspaces and workplace such that gaps (delta) between current and ideal configurations can be outlined. If desired, this could factor into the Design Implications of the new workplace being designed, which module 19 could be added to the system 10 of the invention.

Referring to FIG. 2, a fictional design scenario is illustrated to provide a general understanding of the inventive process. FIG. 2 is understood to be only a general illustration of the process of the invention, which is described in more detail relative to the remaining figures.

More particularly, as a result of the data collection stage of the system 10, a particular business operation can be found to comprise five departments (simplified for illustration purposes) identified as departments A-E in FIG. 2. As noted above, the departments may comprise any number of individuals and typically are defined by the particular real-world operations of the business or organization and how such organization has structured itself to perform the work that it performs. The departments generally are the five groups of the operation being evaluated, and these groups were identified during a group identification step. In the data collection step, each individual of these departments or groups A-E is surveyed in a survey step and these individuals are required to answer questions which identify their work characteristics 13, personal factors 14 and preferably, their demographic data 15. This group identification step and data collection step are generally designated by reference numeral 20 in FIG. 2.

Thereafter, a data analysis step 21 is performed by the computer-based system and the particular Workstyles of these individuals are identified in the Workstyle identification step 22 which generates a Workstyle output designated by numeral 23. The Workstyle identification step 22 includes the step of processing the survey data to identify the individual Workstyles, then tally up those individuals into their Department level, and displaying the dominant Workstyle (or Workstyles) for each Department as indicated by reference numeral 23.

In this exemplary scenario, there are four different Workstyles (out of the 8+3 possible work styles), namely Workstyles 1-4 that are found to be exhibited by the 5 Departments of this organization. From the following discussion, it will be made clear that the inventive system 10 preferably identifies any of eight plus three possible Workstyles or in other words, 11 total Workstyles that may be exhibited by particular individuals. While each individual would exhibit only one of these eight plus three Workstyles, when individual data is tallied up to department/group level, an organization might not have all 8+3 Workstyles. As such, there is no requirement that all Workstyles be represented at an organization.

Many of the Workstyles will depend upon the work characteristics of a particular organization, such that an organization in some industries may exhibit higher numbers of several types of Workstyles, while other organizations in different industries may exhibit higher numbers of other types of Workstyles. As noted above, the Workstyles are identified through a combination of both the real-world work characteristics 13 as well as the more individual personal factors 14.

As to the four Workstyles identified, the different departments have individuals which exhibit different combinations of Workstyles. Since particular Workstyles and the survey information collected provide an indication of design implications, different departments may have different workspace preferences which are identified as the result of this system 10. In this regard, identification step 24 of FIG. 2 determines the design implications which will differ for the various departments A-E and the different Workstyles of the individuals forming such departments. The identification step 24 may comprise a first step of processing the survey data and making the Workstyles determinations and then the step of generating the design implications which are derived from the survey data.

Ultimately, the last step 25 of outfitting an office involves planning specific workstation configurations which will be the basis of consideration to purchase and install in a particular workspace. In the final planning step 25, three different workstation types 1-3 are shown although it will be understood that this is only a general representation of the specific workstations which might be installed. In actuality, any variety of work station configurations may be suggested by the evaluation system 10 and no specific structural configuration is dictated by the system 10. Rather, the design implications are considered and used as guidance by the designer when planning the specific structures to be installed in a space. Further, the final design step 25 represents physical planning of the particular work station configurations. These configurations may be completely constructed by space-dividing wall panels, desks, storage, task lighting, and other components which might be purchased from an office furniture manufacturer.

However, it is also understood that these work station configurations might also use other design features which do not necessarily comprise work station components. For example, one design implication of the invention, to be discussed hereinafter, refers to the level or height of enclosures surrounding individual workspaces. Most cost-effectively, these enclosures may be defined by space-dividing wall panels, although static, built-up wall structures may also be used without departing from the scope of the invention. This provides the architects and designers with significant flexibility in satisfying the design implications.

In the representative process illustrated in FIG. 2, it may be decided that those individuals in Departments A and B having Workstyles 1 and 2 may be best served by a common work station configuration type 1, which configuration equally satisfies the design implications of both Workstyles. Still further, work station configuration type 2 may be developed to satisfy those individuals exhibiting Workstyle 3 of Department B and those exhibiting Workstyle 4 for Departments C and D. Thus, it is possible that different workstation configurations may be developed for individuals of the same department wherein these individuals exhibit different Workstyles and may be subgrouped (using one or more of the aforementioned demographic categories) to better satisfy the individual design implications thereof.

Lastly, work station configuration type 3 may be found to be a most preferred work station for Workstyle 3 exhibited by the individuals of department E. Thus, even though two different departments have individuals exhibiting Workstyle 3, it is not required that these Workstyles be accommodated through an identical work station configuration. As to why Dept B and E, sharing the same Workstyle 3 can end up with different Workstation Configuration Types (1 and 3), the reason is that Workstyles are determined with 5 questions (FIGS. 14 A and B). The remaining questions feed into the design implications, so even if there are two Workstyles that are the same, the remaining questions might differ, thus resulting in two different Workstation Configuration Types (design implications).

It is noted that the eight plus three Workstyles being used in the system 10 are identified through the assessment of extrinsic work characteristics 13 and intrinsic personal factors 14 of the individuals. These work characteristics 13 essentially are the extrinsic expectation or features of the particular job being performed by the individual. These work characteristics 13 are not derived from the individual personality of an employee or worker, but are work-dependent characteristics, and as such, these characteristics can vary greatly amongst different organizations. Hence, the particular Workstyles being exhibited or known to exist in an organization will typically vary and as such, the design implications for individual organizations have been found to also vary.

Further, the structural or physical workspace needs of one organization can vary widely from the physical workspace requirements of another organization based solely upon the type of work being performed by such organization. It has been found that some workspace needs may also be dependent upon the personal factors of the individuals that are performing the job or work. Hence, the unique set of Workstyles that have been developed for this system can comprehensively evaluate both the work characteristics and the personal factors and are not exclusively limited to one or the other.

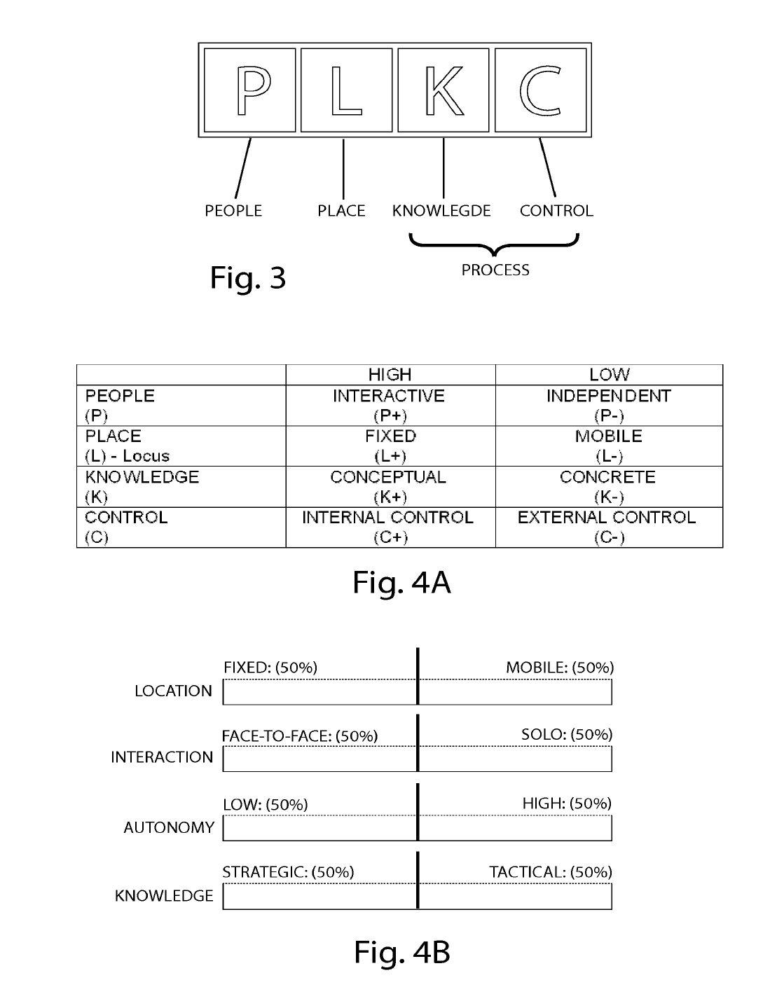

Referring to FIG. 3, the set of Workstyles used by the system 10 preferably are defined by four domains identified as P for People, L for Place or Location (or Locus), K for Knowledge and C for Control. These four domains taken together define the PLKC framework which essentially takes into account these characteristics of the People, Place and the “process” being performed by such People. Essentially, the “process” is subdivided into both the Knowledge considerations of each job, as well as considerations of Control. While a People-Place-Process framework has been known, the more descriptive People-Place-Knowledge-Control framework is an improvement of the invention which breaks out Process into Knowledge and Control to better describe work styles.

During the survey steps, the survey is used to identify or collect data for each of these four domains for each individual. In this regard, each of the domains preferably is evaluated and identified as having one of two opposing poles or domain states such that each individual would be either a P+ (preferably called Interactive) or P− (preferably called Independent) as one example. Generally, the poles or domain states for the People domain are defined by the work characteristics of whether the individual works in an interactive environment or works independently and has little face to face contact with other individuals. The opposing poles for Place (L) are determined by whether the individual typically works in a fixed location or a mobile manner which are indicated by designators L+ (preferably called Fixed) or L− (preferably called Mobile), respectively. The Knowledge (K) domain is evaluated with respect to whether the work that an individual performs on a daily basis is mostly conceptual in nature (K+, preferably called Conceptual) or it is more concrete in nature (K−, preferably called Concrete). A Conceptual work is usually something that involves creating knowledge, that is, coming up with novel ideas (an example would be writing a scientific paper, or designing a new building), while a Concrete work is something where the individual performing such work is just processing information that was created by someone else, in other words doing routine or well-learnt tasks (writing an expense report or scheduling meetings would be good examples here). The Control domain evaluates the conditions of control over one's work encountered by an individual as part of their work. In this regard, the question is whether the worker has internal control of their own work and their workday or work life (C+, preferably called Internal Control) or they work under control of others (C−, preferably called External Control). Someone who is in the Internal Control category has, in the majority of time, control over his or her work and workday: he or she decides when and how to work on different tasks, in other words, he or she schedules his or her own workday or tasks. On the other hand, someone with External Control cannot decide what and when to work on, it is usually decided by others (such as peers or supervisors). A typical example for C+ would be field sales, and for C− would be executive assistant work.

In an alternative embodiment, the PLKC framework may use an alternative naming convention for the four domains, and their respective states. The table below correlates the PLKC framework described herein with one alternative naming convention, which in some settings may be easier for end-users to grasp:

TABLE 1

| | PLKC Alternative Naming |
|---|---|
| PLKC Framework | Convention |
| People | Interaction |
| P+ | Face to Face |
| P− | Solo |
| Place | Location |
| L+ | Fixed |
| L− | Mobile |
| Knowledge | Knowledge |
| K+ | Strategic |
| K− | Tactical |
| Control | Autonomy |
| C+ | High |
| C− | Low |

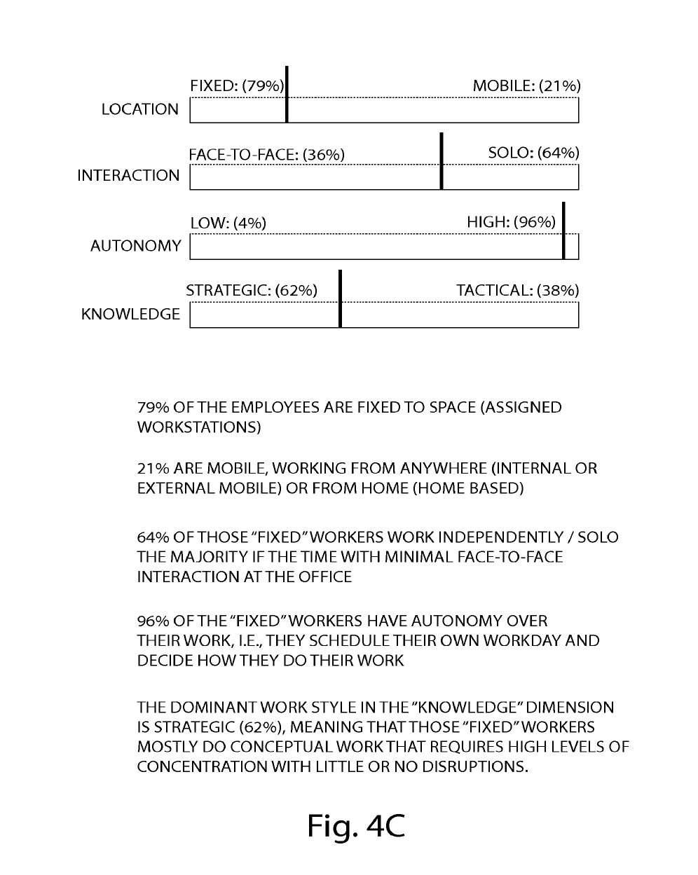

Generally, each domain is identified with its domain state as either a plus or minus, wherein the plus or minus are convenient designators and any other equivalent either/or designator may be used. Of course, an alternative naming convention, such as the one identified above, may be used to identify the domains and their respective domain states. Most preferably, the domains are evaluated based upon two states or poles wherein one or the other exists. For example, as to FIGS. 4A and 4B, the People domain (or Interaction domain) is evaluated whether the individual has high interaction with others as part of their job, or if such interaction is low, then they would be found to have an independent domain state for the People domain (or Interaction domain). For convenience, the states or poles of each domain are indicated in FIG. 4A by the plus or minus such that: People is designated as either P+ or P−; Place is designated by either L+ or L−; Knowledge is identified by either K+ or K−; and Control is identified by either C+ or C−. The states or poles of each domain are indicated in FIG. 4B by a percentage scale. The applicable pole or domain state for each individual for each of these four domains is identified during the survey step through the use of appropriate survey questions that require the individual to select an answer that is indicative of either one of the states for each of the four domains.

In more detail, the following provides additional discussion of each of the four domains and the conditions in which the poles or domain states exist.

People or Interaction

Referring to “How do people work?” or to “people connection,” which is whether someone needs to be connected with others (face-to-face) most of the time, or need not to be connected, that is, working independently. In other words, this domain addresses interaction such as whether people interact face-to-face or work solo.

Interactive (P+) or Face to Face

People in this category need to be connected with people. They are usually largely dependent on face-to-face interactions with others in the office. They usually cannot successfully complete work alone with only phone, e-mail, or Internet connection; they are more dependent on face-to-face interactions with others to complete their work.

Independent (P−) or Solo

People in this category do not need to be connected with others. They are usually largely independent of face-to-face interactions with others in the office, or in other words, with minimal face-to-face interaction. Although they may need to meet with co-workers a few times a week, they can usually successfully complete work alone with only phone, e-mail, or Internet connection.

Place or Location

Referring to “Where do people work?” or to “place connection,” which is whether someone needs to be “tethered” to space most of the time, or need not to be connected to space, that is, working mobile, where space does still matter, but where does not matter.

Fixed (L+)

People in this category are connected to place, or “tethered” to space most of the time. They need to be in their workspace most of the time, and they usually spend their entire workday at their workstation, or spend parts of some days working away from their desk, inside or away from the office.

Mobile (L−)

People in the “mobile” Workstyle categories are not connected to place, or in other words, are more mobile and less tethered to physical space. There are 3 sub-categories under the Mobile category: Internal Mobile, External Mobile, and Home Based. Workers in the internal mobile category are mobile within their organization's physical premises, that is, within their office or campus setting. Workers in the external mobile category are more mobile and their mobility extends outside of the physical premises of their organization. They can basically work from anywhere, such as while traveling, at client sites, or in public spaces (cafes, terminals, airports, hotels, etc), but not dominantly from their home. This category is reserved to the Home Based category, where workers are working from home in the majority (usually 3 or more days per week) of their times.

Knowledge

Referring to “What kind of work people do?” or to “knowledge connection,” which is whether someone is creating knowledge or performing strategic work (conceptual—e.g. writing or editing a white paper or a client report), or processing information or performing tactical work (concrete—e.g. working on an expense report, or checking email).

Conceptual (K+) or Strategic

People in this category do work most of the time that involves creating something new or novel, and require full attention without distractions. Thus, they always or often need to concentrate intensely and should not be distracted at all; however, a few distractions during the day might be acceptable.

Concrete (K−) or Tactical

People in this category most of the time do work that involves processing information, mostly in a routine way, thus they only sometimes or rarely need to concentrate intensely, so frequent or even constant distractions during the day are acceptable for them.

Control or Autonomy

Referring to “How much control do people have over their work?” or to “direction of control,” which is whether someone controls his or her own work, or it is controlled by others.

Internal Control (C+) or High Autonomy

People in this category usually schedule their own workday and decide how to do their work, although occasionally they need to change their schedule to accommodate their managers or direct reports' requests.

External Control (C−) or Low Autonomy

People in this category usually do not schedule their own work; it is usually jointly determined with other people and they usually work with others to determine how to do their work.

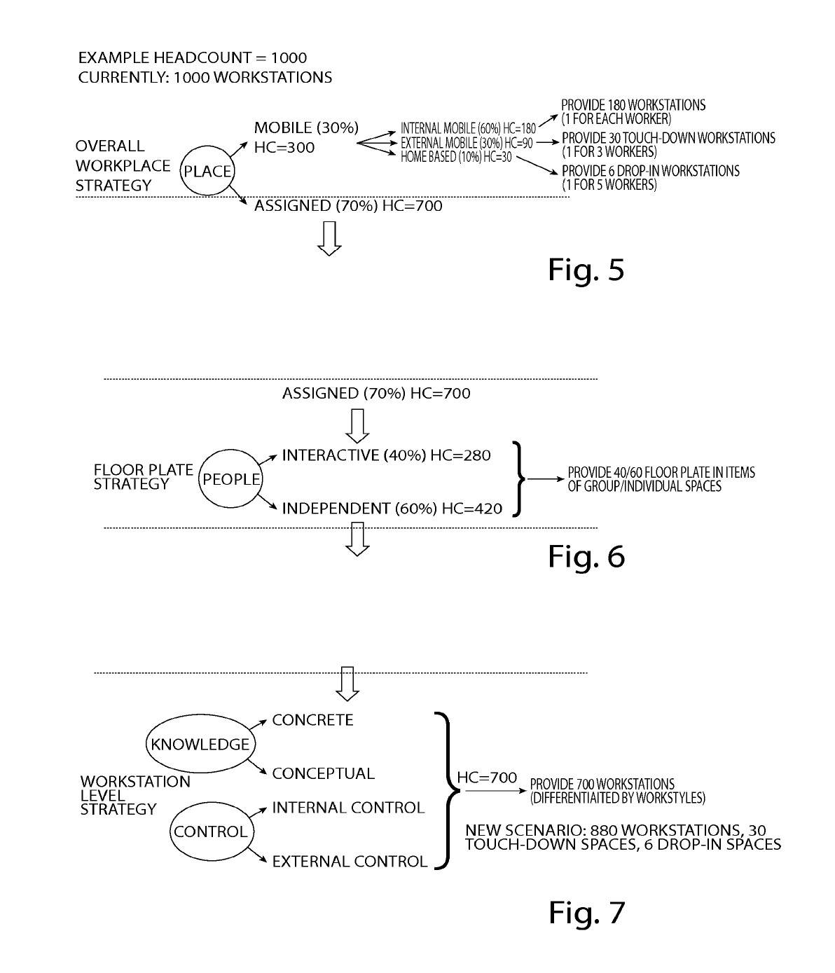

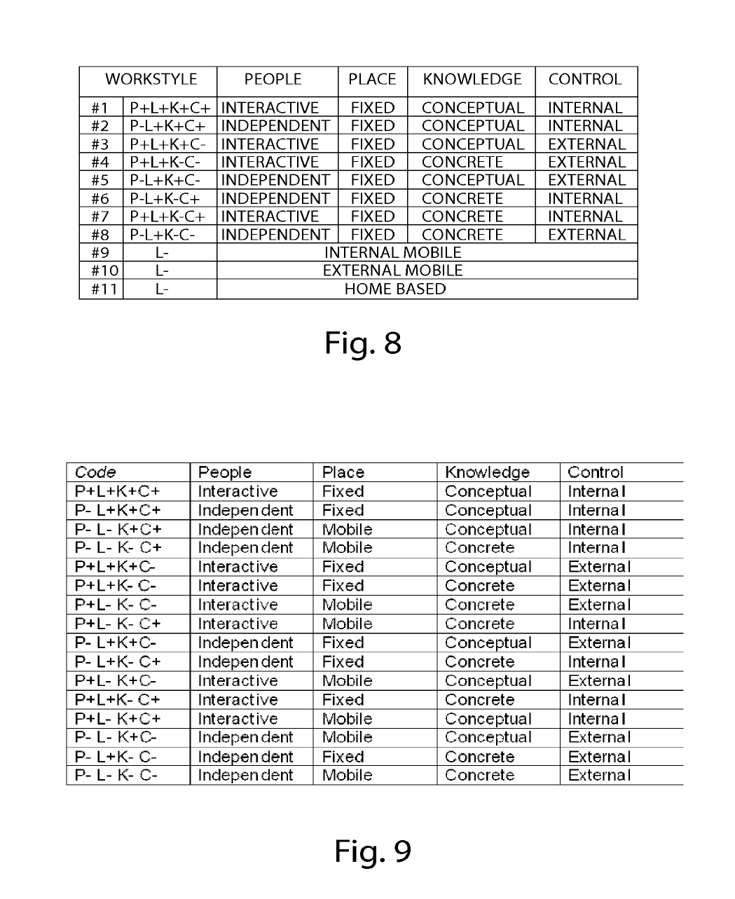

The identification of the 4 domains and their bipolar domain states (FIG. 4) ultimately generate 16 possible different combinations of such domains, from P+L+K+C+ to P−L−K−C−(FIG. 9). However, for practical purposes, these 16 combinations were simplified and all 8 combinations where L− (Mobile) is included were combined into one single category: Mobile. Then, as mentioned already above, the Mobile category is broken out into 3 categories as per where people work: Internal Mobile, External Mobile, and Home Based. Thus, this logic leaves us with the final 8 (Fixed) plus 3 (Mobile), altogether 11 possible workstyles. The 8+3 workstyles are the preference of this invention, but the invention is not limited to such combinations, as one might later decide to use all 16 workstyles, or only 8 of them, etc. As will be discussed in further detail hereinafter relative to FIGS. 8 and 9, there are eight Workstyles associated with the different combinations of plus and minus values which exist when the Place (or Location) domain is identified as fixed or L+. When the Place (or Location) domain and the domain state thereof is fixed, the different combinations of People (or Interaction), Knowledge and Control (or Autonomy) provide eight different combinations of Workstyles. When an individual is found to have a mobile domain state identified as fixed or L−, the system of the invention therefore subdivides this domain state into three different possible Workstyles depending on whether the individual has a mobile working environment and is totally mobile within a company, or externally mobile with third parties, or in a third option, mobile but primarily home-based. In these 3 cases, the other 3 domains (People, Knowledge and Control) are no longer relevant, and thus not counted. This will be described in further detail herein, but FIGS. 5-7 generally illustrate how the different domains can affect the type of workspaces provided within an organization's facility (the numbers in FIGS. 5-7 are purely for illustrational purposes).

With respect to FIG. 5, the Place or Location domain is one particularly relevant factor when considering how many of an organization's head count have mobile working requirements, as opposed to others of this total head count which have assigned or fixed spaces. FIG. 5 provides one sample scenario wherein the total head count is 1,000 and there currently are 1,000 work stations within the organization's facility. However, the system 10 of the invention may then identify that 30% of the workforce or head count, i.e. a head count of 300 employees, are actually mobile-type workers who do not necessarily require assigned or fixed work stations.

In this regard, the system 10 may help identify that of this group of 300 mobile workers (mobile or L−), 180 or 60% thereof are internally mobile and then would preferably be allotted 180 work stations (1 for each worker). Of the total group of mobile workers, 30% or 90 individuals may be externally mobile and it may then be desirable to only provide 30 touch-down work stations for them (only one for every three externally mobile workers). In many cases, not all of these externally mobile individuals will be present on any given day at the facility, such that it is not necessary to incur the costs associated with providing a space for each of these individuals. As another subgroup, there may be 30 individuals or 10% of the mobile workforce that are home-based, and it may only be necessary to provide six “drop-in” workstations for such workers or namely one in five of the home-based workers since they are in the facility even less than externally mobile workers.

As to the remaining 70% of the workforce that are fixed in place (Fixed or L+), FIG. 6 further illustrates how these workers are evaluated relative to their People domain. Of this group of 700 workers, 40% or 280 may be found to be Interactive (Face to face or P+) which may be best suited by providing group working spaces or work stations for them. The remaining 60% or 420 head count of these individuals may be found to be Independent (Solo or P−) and may be best suited by individual workstations assigned specifically to them.

FIG. 7 further illustrates how these 700 workers may also be evaluated relative to the Knowledge and Control (or Autonomy) domains wherein the types of the group or individual workspaces may then further be designed with guidance derived from the Knowledge and Control domains.

In this manner, consideration of the four domains of Place, People, Knowledge and Control allows for the generation of design implications, which can better suit an office space to the particular work characteristics and personal factors of the individuals working in such spaces.

Referring to FIG. 8, FIG. 8 illustrates the People, Place, Knowledge and Control domains and their domain states and how these combinations of domain states generate the Workstyles. Eight Workstyles are associated with the fixed, L+ Place domain which indicates the individuals having these Workstyles have fixed Place requirements. As for the L− mobile domain state, where the other domain states (P, K, and C) can preferably be considered irrelevant, this domain state is then subdivided into three Workstyles, namely internal mobile, external mobile and home-based. Hence, the system 10 of the invention uses eight plus three Workstyles, namely the eight Workstyles #'s 1-8 which exist when the Place domain is fixed or L+. The three remaining Workstyles #'s 9-11 are defined when the Place domain is mobile or L−. FIG. 9 is provided as a complete table showing all of the theoretically possible combinations of the domains and domain states and ultimately shows that the eight possible combinations when the Place domain is mobile L−, are ultimately reduced to the three Mobile Workstyle #'s 9-11.

As will be described relative to the survey questions, the survey questions are able to identify the domains and domain states directly from the survey answers. Additional questions are also included which collect more information to help suggest design implications (Output level II—see FIG. 1). Finally, personal factors are measured implicitly with different questions: the way people answer different questions reveals implicitly their different personal factors. Therefore, these personal factors do not measure an individual's personality but rather only assess some intrinsic characteristics or preferences of the individual. In this regard, the personal factors therefore evaluate the introversion or extraversion of the individual, their screening ability which relates to how well they are able to screen out distractions and whether this ability is high or low, and their locus of control as to whether their intrinsic needs relate to internal control or external control. Hence, these personal factors are also identified in the survey stage and considered as part of the system 10.

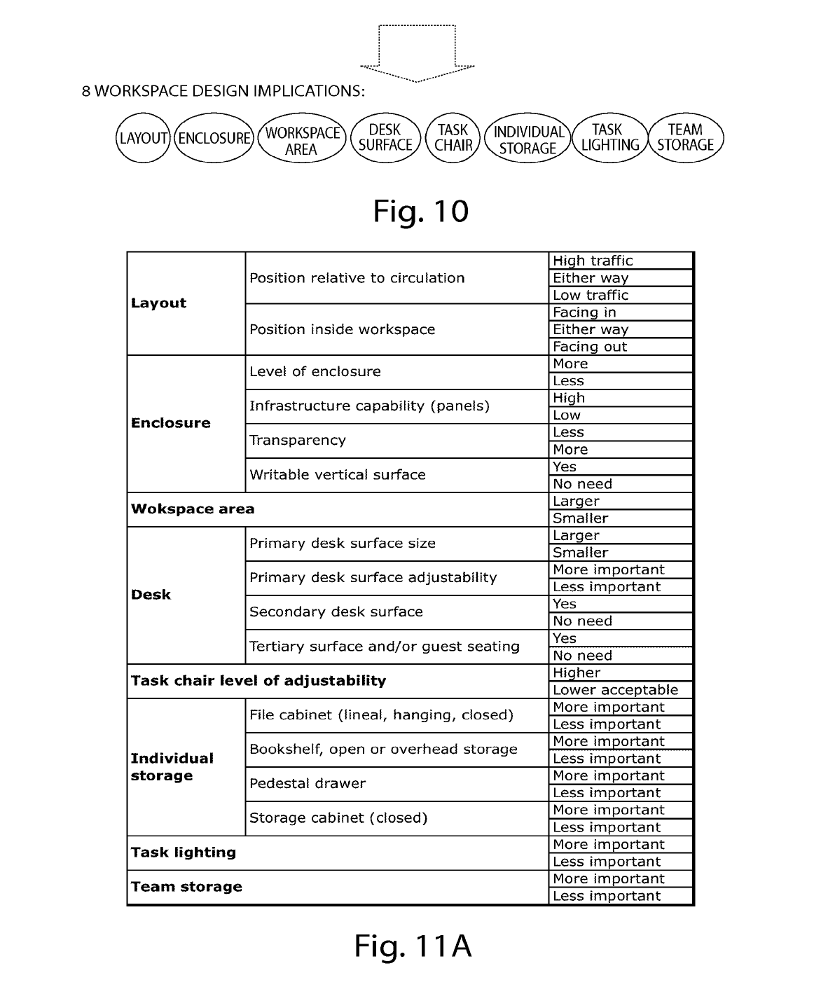

As described below, the survey questions not only identify the Workstyles (17 in FIG. 1.) but also generate Design Implications (18 in FIG. 1.) FIG. 10 illustrates eight preferred workspace design implications and more specifically, eight main categories of design implications that are considered as part of the system 10. These design implications include Layout, Enclosure (or possibly Panels), Workspace Area, Desk Surface, Task Chair, Individual Storage, Task Lighting and Team Storage.

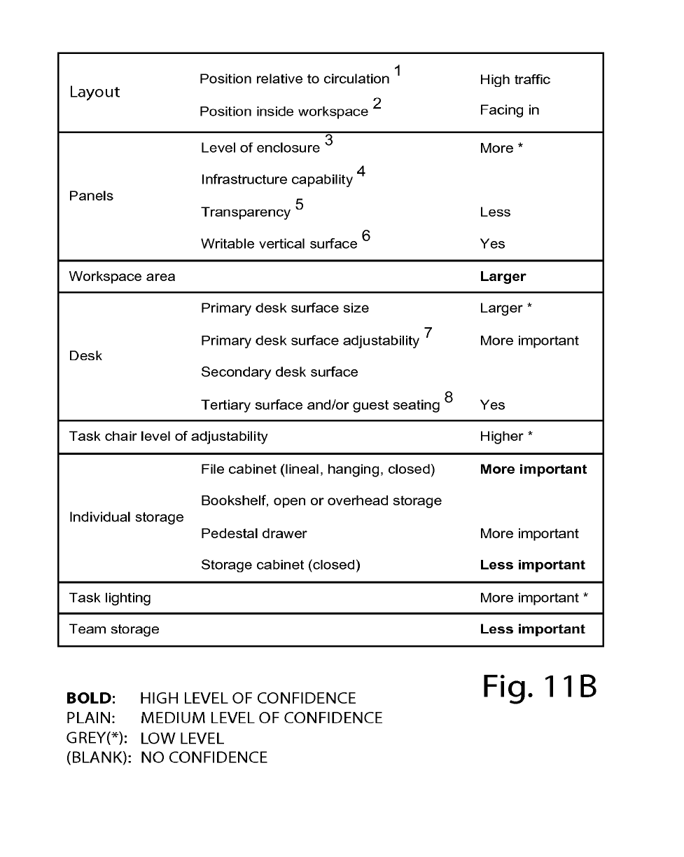

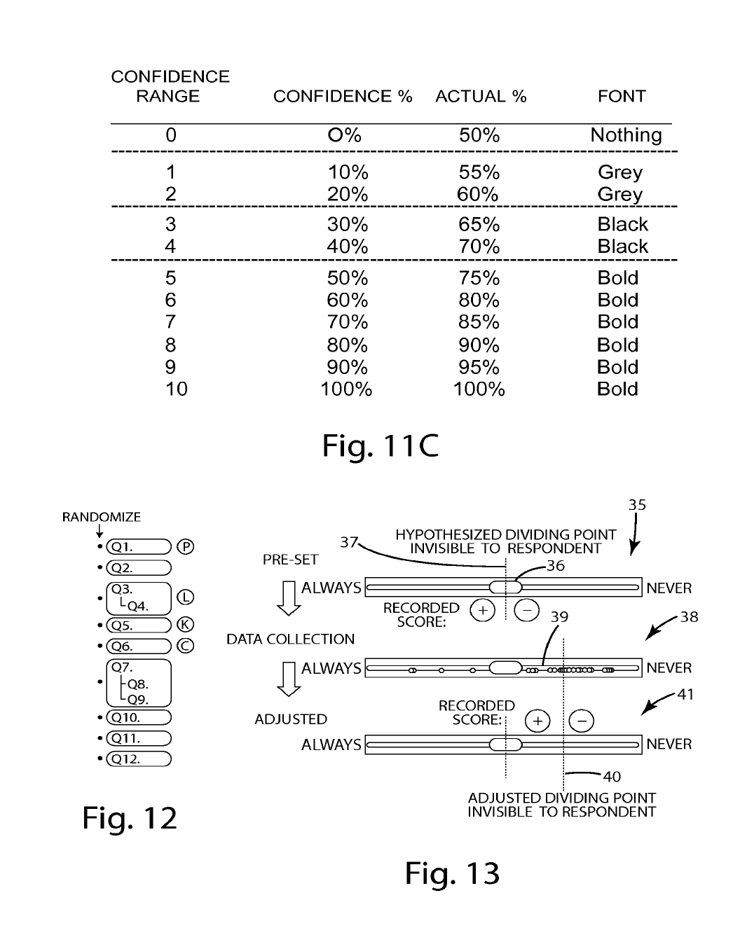

When generating the design implications, the design implications are not dictated solely by the eight plus three Workstyles, but instead rely upon a combination of the Workstyles referenced by 5 questions namely Questions Q1, Q3, Q4 Q5 and Q6 as seen in FIG. 14A and the additional information collected with Q2 in FIG. 14A and the remaining survey questions (see FIG. 14B). By generating these design implications with the inventive system 10 for an organization, this provides design guidance at the group level to assist in outfitting an office space. With respect to the design implications, FIG. 11A illustrates the specific implications preferably generated for each of the main implication categories of FIG. 10.

The intent of these design implications is not to suggest quantitative information (such as cubic feet of storage, or inches of partition height) and is not to dictate the specific workspace structures. The design implications, or recommendations for individual workspaces are more generally established in relative terms (such as “storage more important” or “more enclosure needed”). The implications are then taken into account by the client's space designer while also taking into account the client organizations' design guidelines, if applicable, to develop the absolute space requirements for the individual workspaces.

FIG. 10 summarizes the preferred design implications grouped into eight main categories. These categories are the preferred categories although the invention is not limited and there may be more or less of these categories or even different categories. The main categories may be subdivided into two or more specific implications (as illustrated on FIG. 11A) such as Layout, which has two implications associated therewith, and Enclosure which has four implications associated therewith. Alternatively, a category by itself may directly define a design implication such as Workspace Area, Task chair level of adjustability, Task Lighting, and Team Storage, and the term “design implication” equally applies to this scenario.

Each design implication typically has two or more possible options associated therewith, wherein the system 10 evaluates the workstyles and other supportive information and makes a determination which of the options applies to each individual being evaluated. As such, the first round of evaluation, just like the Workstyle evaluation is on the individual level, which then will be tallied up to the group (such as department) or sub-group level. This will be discussed later in detail relative to FIG. 11B and the logic of confidence levels.

In further detail, the Layout design implication category preferably comprises two design implications. The first is “Position relative to circulation”, which refers to whether the individual workstations should be in an area with a high level of circulation or traffic (such as next to a main circulation or traffic route) or a low level of circulation or traffic (such as dead-end areas). If high traffic or low traffic is not found to be an important requirement, “either way” may be the design implication. Thus, three status identifiers or options are used.

The second is “Position inside workspace”, which refers to whether individuals in their workspace (or workstation) should be facing in (towards a partition, wall, or corner) or facing out (to the circulation route/entrance of workstation). Facing out usually means a direction which allows for eye-contact with passersby or with people dropping in. Here again, “either way” may be the design implication. Here again three status identifiers are used.

Next, the Enclosure category comprises four implications. Level of enclosure usually refers to the number and height of partitions and the combinations thereof which defines the partition walls that subdivide the office space, define the perimeter of the workspace, and separate the workspaces from one another as well as walkways. Two status identifiers are used for this design implication. As noted before, such enclosure is not limited to furniture partitions, as enclosure can be obtained with other, non-furniture related physical objects, just as dry-wall, curtain, etc.

The level of enclosure, as all other design implication items are provided in relative terms (“more” or “less”); the absolute level of enclosure (such as in inches) must be determined by the designer, taking into account the current workplace setting and the relative design implications. So if the current setting is 60 inches high partitions, and the indicator is “less,” the designer might want to provide 50 or 55 inches, but not 65. As a rough guideline, however, less level of enclosure usually means “below the level of seated privacy.” “Seated privacy” means that one cannot see over his or her partition while seated; however, one can see over the same partition when standing, thus having visual privacy only when seated. Similarly, more level of enclosure usually means “seated privacy or above,” meaning that the top of the enclosure or wall is above eye level when seated, thus one can not see out of his/her workstation when seated, however, one might be able to see out when standing. Enclosure can also be provided with a variety of ways, such as seated next to a wall, with file cabinets, planters, etc. Further, many wall panels may have portions of see-through panels such as glass, or may even be entirely glass paneled from top to bottom (this will be addressed under “Transparency”). Thus, the level of enclosure may not be limited necessarily to the top edge of the wall panel.

The next design implication is the infrastructure capability, which refers to power, data and telephony, preferably built into the partitions or wall panels of one's workstation. A workstation may have high or low infrastructure capability requirements.

The third design implication for Enclosure is Transparency. “Less” transparency usually means providing opaque or translucent space dividing structures, such as wall panels, while “more” transparency usually means providing transparent panels or means of enclosure (such as a wall with windows).

The fourth design implication relates to writable vertical surface, which refers to the vertical surfaces within one's workstation (such as the inner side of a panel or the side of a cabinet) that are intended to be writeable. Usually such surface is made of, or is provided with a separate panel usually made of a shiny, white coating that is writeable and erasable with a dry-erase marker. The writable surfaces are not limited to such, and may be any writable surface provided on the enclosure surfaces, including electronic panels. This implication is designated by whether it is needed or not, although it could be designated by level of importance, or quantity or area.

As to Workspace Area, this essentially is the total area of the workspace allocated (permanently or temporarily) to an individual in which the individual performs his/her job or work functions. This category therefore functions as both a main category and a design implication, and it is possible that these functions may be separated if additional implications are identified relative to the workspace area.

As to the Desk category, the “Primary desk surface size” refers to the relative size of one's desk where he/she performs his/her work: this usually is, but is not limited to, the surface where one has his/her computer keyboard and monitor, thus used most of the time. This is identified by a relative magnitude as being “larger” or “smaller” which indicates the general level of quantity of desk area.

The second implication is the “Primary desk surface adjustability” wherein adjustability primarily refers to vertical adjustability although other levels of adjustability may be considered such as tilt. This implication is identified by level of importance such as more or less.

The third and fourth implications relate to a “Secondary desk surface” or a “Tertiary surface and/or guest seating”. Secondary desk surface is usually, but is not limited to, the surface immediately adjacent to the primary desk surface where one places reference materials while performing his/her work. This could also be a place for auxiliary equipment, such as printer, scanner and the like. Tertiary surface refers to a third work surface, in addition to a secondary one; this is usually, but is not always used for quick meetings, thus the invention combines this with guest seating, which refers to an extra seating surface that a drop-in guest can sit on (could be a chair or a plurality of chairs, but could also be an upholstered pedestal.) These implications are identified by either needed or not status identifiers (yes/no need).

The Task Chair Level of Adjustability is another category that also directly defines a design implication, and refers to the adjustability (height, arm rest, lower back, etc.) of one's main task chair where one is seated while at his/her workspace. While it is important for every individual to have a highly adjustable ergonomic chair, in some cases (for example when one spends considerably less amount of time at his/her workstation, such as Mobile) lower adjustability can be accepted for economic reasons, hence the two status identifier: “higher” or “lower acceptable.”

Individual Storage preferably includes 4 categories that are based on inventors' previous research: File cabinet refers to lineal or hanging filing systems that are usually closeable with a cabinet door; Bookshelf, that can also be an overhead storage (affixed to panels); Pedestal drawers that usually slide or roll under desks; and Storage cabinets that are also usually closed but are used for different purposes than filing files (e.g. reference materials or reference objects). All categories have two status identifiers: more important or less important. Generally, therefore, this category comprises design implications that relate to specific types of office furniture products or equipment.

Task lighting is another category that directly defines a design implication: task lighting is an auxiliary lighting provided in addition to general overhead lighting, at one's workstation, usually at desktop level, and usually directly controllable by the worker. The two status identifiers relate to the importance of such feature in one's workspace.

The last item is Team Storage, that also directly defines a design implication: this is the only design implication that does not relate to specifications within one's workspace, but refers to the importance of team storage usually provided around a team space (a cluster of individual workspaces).

As can be seen, the design implications can provide different types of information and provide guidance as to specific types of furniture preferred or not, features of such products, general features as to the configuration, layout and location of the workspace, and information as to the positioning and work conditions of the individual using the workspace.

More particularly as to the data collection, this is accomplished through a relatively short survey provided to each individual of a business or organization. The survey data is stored individually and then analyzed by the system 10 to develop the workstyle output and design implication output described herein.

FIG. 12 diagrammatically depicts the survey questions, which are numbered in sequence but randomized during the survey taking stage. Generally, Questions 1, 3, 4, 5 and 6 are questions wherein the answers to which indicate the domain states for each of the domains People (P), Place (L), Knowledge (K) and Control (C). Question 3 is a so-called “gateway” question which identifies if the individual is L+ Fixed or L− Internal Mobile and if none of these, then this leads to Question 4 that identifies whether the individual is External Mobile, or Home Based. Hence, the Workstyle Domains are identified through these five questions. Additional Questions 2, 7-9, 10, 11 and 12 provide additional data for the design implications for each individual. Question 7 is also a “gateway” question, as Q8 and Q9 are only triggered if someone answers Q7 in a certain way. Thus, the total number of questions in the survey, depending on the gateway questions, can be between 9 and 12. Not only the survey questions are randomized, but in some questions, answer choices are also randomized. It is a usual practice in survey design to randomize questions and answer choices wherever possible to reduce the effect of “survey fatigue.” Respondents tend to show fatigue toward the end of surveys, and thus do not pay as much attention to later questions as they do to earlier questions. Randomizing survey questions provides “equal chance” for each question to appear earlier. The same goes for answer choices.

Referring to FIGS. 14A and 14B, the questions are described in further detail. Preferably, the questions are presented through a computer-based survey that can be used through an online survey tool. As for displaying the preferably online survey interface, a computer monitor, touch screen, “smart phone” (mobile phone capable of browsing the Internet), LCD screen, or the like might be used. FIG. 14C shows a language selection screen (that is only displayed when other languages besides the default English are set up) where users can select a desired language (preferably the user's native language) pre-set by the system/survey administrator. Any language can be uploaded into the system after translating the survey into the given language. This is preferably done on an on-demand basis. As seen in FIG. 14D, the survey tool is accessed through a startup screen 26A (after the language selection screen) and initiated through a start button 26B to begin the survey. Such startup screen (and the entirety of the survey thereafter) is displayed in the language the user selected on the language selector screen, otherwise English is the default language. At the beginning of the survey, the questions are loaded on the device being used with the survey questions being presented one at a time in randomized order.

In further detail, Question Q1 may explore how the individual works wherein the answer A1.1 if selected identifies whether the individual is P−/Independent while A1.2 identifies the individual as P+/Interactive if selected. The answer options are also randomized, so A1.1 might be above or below A1.2 on the survey page. FIG. 14F illustrates a first question screen (generated by the system in random order) 27A on which the Question Q1 is presented along with answers A1.1 and A1.2. The survey taker selects an answer by clicking the answer button 27B which then records the data for subsequent processing. Each of the question screens includes forward and back arrows 27C and 27D to either move to the next question or back up for correction of a prior question. The various multiple choice questions described below use a similar screen format.

Question Q2 inquires how the individual works relative to others. This question is not tied to a specific domain but is factored into the determination of the design implications. The answers determine if the individual works:

A2.1 Alone;

A2.2 In collaboration with others+in the organization+internal to his or her group;

A2.3 In collaboration with others+in the organization+who are external to his or her group; and

A2.4 In collaboration with others+outside of the organization.

Question Q3 identifies the Domain (L/Place) by inquiring of the individual where he or she works. The answers are formatted to determine if the individual is one of the L Domain types as follows:

A3.1 (L+/Fixed) determined by the individual primarily working at their workstation. If selected, then skip Q4 and go to Q5 since the individual will have the L+ identifier associated therewith;

A3.2 (L+/Fixed) is also determined if the individual often works in their office and also spends time in other office areas. If selected, then skip Q4 and go to Q5;

A3.3 (L−/Internal Mobile) If selected, then skip Q4 and go to Q5;

A3.4 (L−) is determined if the individual often works away from their office in other office areas, this answer choice triggers Q4;

A3.5 (L−) is determined if the individual often works entire days outside of the office at other locations, this answer choice triggers Q4; and

A3.6 (L−) is determined if the individual almost always works outside of the office at other locations; this answer choice triggers Q4.

Notably, the domain state determined by answers A3.1-3.3 is associated with the individual by its selection and further refinement is not required. However, the Mobile domain is Internal Mobile if question A3.3 is selected, and if not this type of Mobile domain as indicated by selection of questions A3.4-3.6, then refinement is provided by Question Q4.

Question Q4 refines A3.4, A3.5, and A3.6 by determining the percentage of time that the individual spends time at their home versus other locations. The answer choices for this question appear in random order on the survey thus A4.1 is not always on the top.

In one embodiment, the individual being surveyed may be asked to subjectively divide 100% between four different locations, namely:

A4.1 Overnight commuting or travel which may indicate L−/External Mobile;

A4.2 Home which may indicate L−/Home Based; A4.3 At other business offices or locations which may indicate L−/External Mobile; and

A4.4 other meeting places which may be non-business locations and may indicate L−/External Mobile depending upon how much of the individual's remaining time is spent at home.

If the individual spends a substantial amount of time working at home, such as 50% or more of their time, and either A3.5 or A3.6 is selected indicating the individual spends entire days away from their office, then the individual would be designated as L− Home Based. If the individual spends entire days away from their office but A4.2 Home Based is less than 50%, then the individual would be classified as L− External Mobile.

In Q4, dividing 100 points across 4 different locations is preferably done by the survey participant adjusting a vertical slider that depletes a “points pool” of 100%.

After Questions Q3 and Q4 have been answered, the L− determination has been designated as being any one of Internal Mobile, External Mobile or Home Based.

Next, Question Q5 is directed to determining the Domain State for K/Knowledge. Answers A5.1 K+/Conceptual and A5.2 K+/Conceptual in one format may inquire as to the concentration required and may differentiate based upon the amount of distractions that are acceptable. Answers A5.3 K−/Concrete and A5.4 K−/Concrete are selected if concentration is only required sometimes or rarely and distractions are permitted. The selection of one of these answers thereby indicates whether the individual is K+ or K−.

Question Q6 determines (C/Control) depending upon answer A6.1 which identifies C+/Internal Control or A6.2 which identifies C−/External Control. The question can be phrased by inquiring as to the amount of internal or personal control the individual has over their daily schedule relative to other individuals' external control over that schedule. These answer choices are randomized.

By the above questions (except for Q2) of FIG. 14A, the domains states for all four Domains are determined. The additional questions of FIG. 14B provide further details to better inform the design implications outcome.

Question Q7 is directed to the Storage of Work Materials and the degree of storage between computers and paper. FIG. 14G shows a question screen 28A for this question. Preferably, the answer is determined by a sliding scale 30, for example, as seen in FIGS. 14B and 14G. A sliding scale 30 is displayed on the monitor of the computer terminal or other input device on which the individual is taking the survey. The user is asked to slide the virtual slide 31 on the screen to indicate the percentage ratio of computer storage 28B to paper storage 28C. If Computer Storage is greater than or equal to 90% with 10% being paper storage, then the survey skips Questions Q8 and Q9 and goes to Q10. If Computer Storage is less than 90%, then the type of physical resources including paper storage materials is evaluated in Question Q8. For example, FIG. 14G shows 30% storage “on my computer” and 70% storage “on paper”. As such, clicking the forward arrow on the screen 28A would then proceed to Question 8.

In Question 8 as shown in FIG. 14H, the individual splits 100% between a plurality of different types of storage materials A-D which, for example, may be reference materials, types of paper files, other physical resources such as prototypes, product samples, and the like. The user interface of this question may preferably be screen 29A which would be similar to Question 4, where dividing 100 points across 4 different locations is preferably done by the survey participant adjusting vertical sliders 29B, 29C, 29D and 29E that depletes a points pool of 100% represented by a vertically moving points pool indicator. For example in FIG. 14H, the slider 29B is set by the survey respondent at 5 (which means that 5% of the physical resources are reference materials), the slider 29C is set at 5 (which means 5% of physical resources are long term paper files), the slider 29D is set at 61 (meaning 61% of physical resources are short term paper files) and the slider 29E is set at 10 (representing 10% are work related reference objects). This leaves a points pool of 19 shown by indicator 29F which thereby indicates that 19% is not yet allotted. The forward button will only move to the next question screen once 100 points are allotted to sliders 29B-29E and the points pool indicator 29F reads 0.

Question Q9 then inquires as to the Sharing of Storage Materials by the individual with others. The sliding scale 32 has a slider 33 which is slid to indicate the ratio of exclusive use by the individual and sharing with others.

Additionally, the survey inquires as to confidential information that might be encountered in a given day. Question Q10 inquires as to how much Confidential Information will likely be Read/Written in a day, and inquires as to different levels of frequency in Answers A10.1-A10.4. Question Q11 similarly inquires as to the frequency that the individual will need to verbally discuss Confidential Information.

FIG. 14I shows question Q12 that inquires as to the types of Electrical Equipment in the individual's workspace which will create physical design implications. Any number of types of office equipment and other devices can be listed, wherein the individual would select each device present in their workspace. Obviously in this question, more than one answer can be selected. If the particular electrical equipment that the respondent possesses is not shown on the list, the respondent can list these by typing them into the box provided under the “Other electrical equipment” in the lower right corner.

At the end of the survey, various Demographic Questions would be asked to supplement the survey results and allow the reports to be filtered by demographic features. These questions also assist in determining generalized groups to which the individual belongs by evaluating job level, such as executive, leadership, management and the like; job type, such as administrative support, technical or professional, customer focus, and the like; gender; age; etc.

Preferably, the Demographic Questions also inquire as to length of employment (tenure) with an organization. Preferably, if the individual has been with the organization less than 6 months, the data may be ignored since the individual may not have enough experience with the organization to provide reasonably accurate data.

As to FIG. 13, an alternate slider may be implemented where the dividing point adjusts over time. In this regard, the slider 35 is shown with Always and Never (these are just examples for illustration purposes; if such slider is used for example at Question 7, “on my computer” and “on paper” would be shown) at the opposite ends of the scale and the slide 36 at a hypothesized starting dividing point (which can be in the middle) 37, and the recorded score being measured + or − relative to point 37. After data collection step 38, the data points 39 may begin to cluster or concentrate above or below the hypothesized starting point 37. It may then be desirable to adjust the dividing point to location 40, as the mean or average of all data points and the + or − data relative to this location 40 is then recorded relative to this location 40 in subsequent data collection step 41. The individual never sees the dividing points 37 or 40 but this allows for adjustment of the data if desired, and thus will result in more precise measurements over time.

With the above survey method, a Workstyle is determined for each individual, which Workstyle is any of Workstyles #1 through #11 of FIG. 8. Thereafter, the design implications are also determined by the computer-based evaluation of the results.

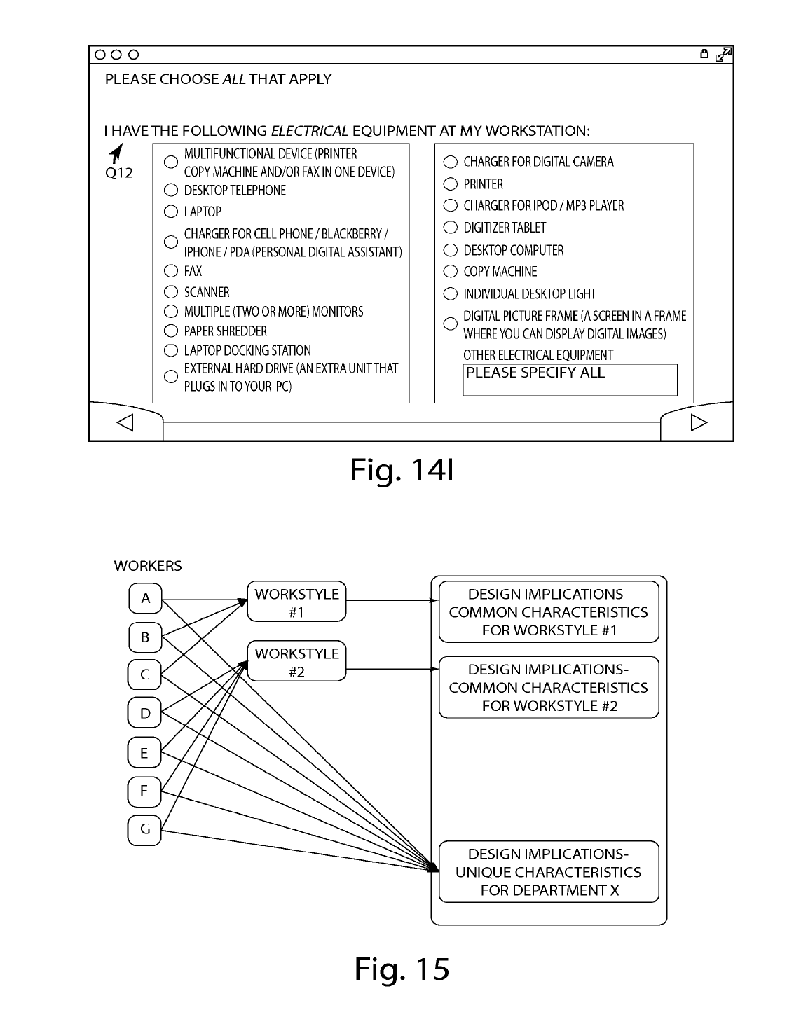

Referring to FIG. 15, a representative drawing is provided indicating that individual workers A-G have taken the survey and as an example Workstyles #1 or #2 are the group level aggregate dominant workstyles where individual workers fall into. It has been found that certain Workstyles may have one or more common characteristics associated therewith that allow for some of the design implications to be predetermined solely based upon the Workstyle. That is, same workstyles will have the same limited set of design implications, regardless of other information (such as other questions in the survey). FIG. 15 shows that Workstyles #1 and #2 each have their own respective characteristics, which impacts some but not all of the design implications.

FIG. 15 also shows, by additional arrows directed to the Design Implications box, that the Workers A-G have answered additional survey questions that are relevant to additional design characteristics. Because the individuals of each organizational group may be uniquely different, these additional design implications may vary simply based upon the unique individuals that work in the same group. Thus, Department X with its Workers A-G may have its own unique characteristics that differ from other Departments in the same organization.

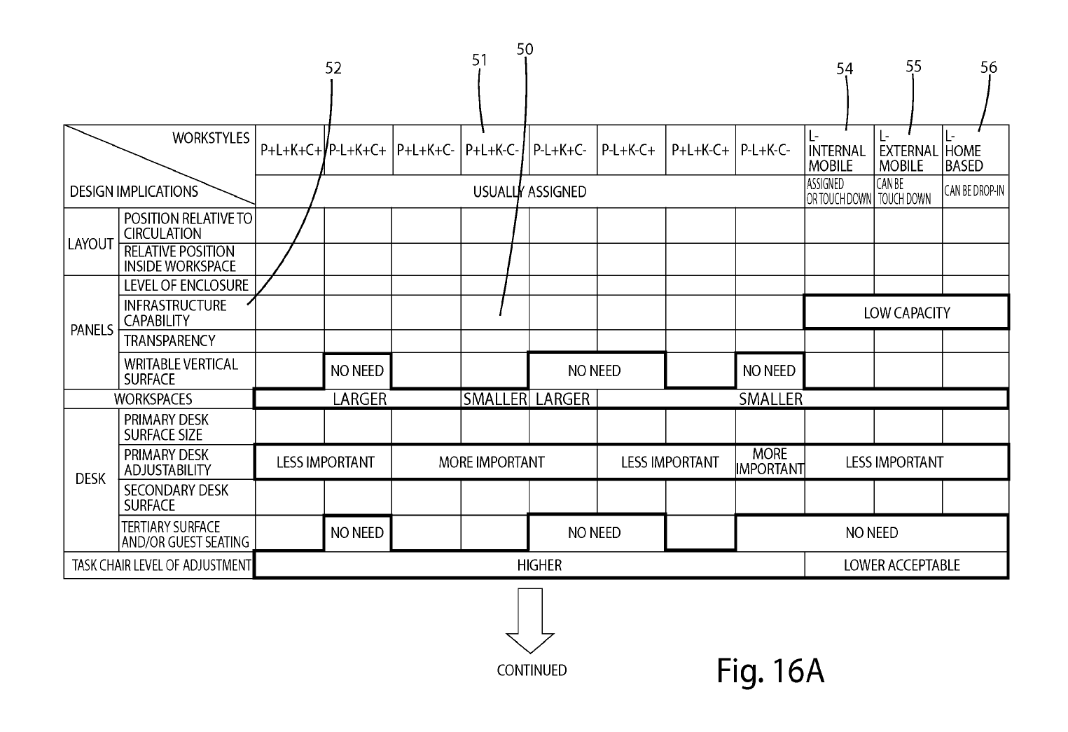

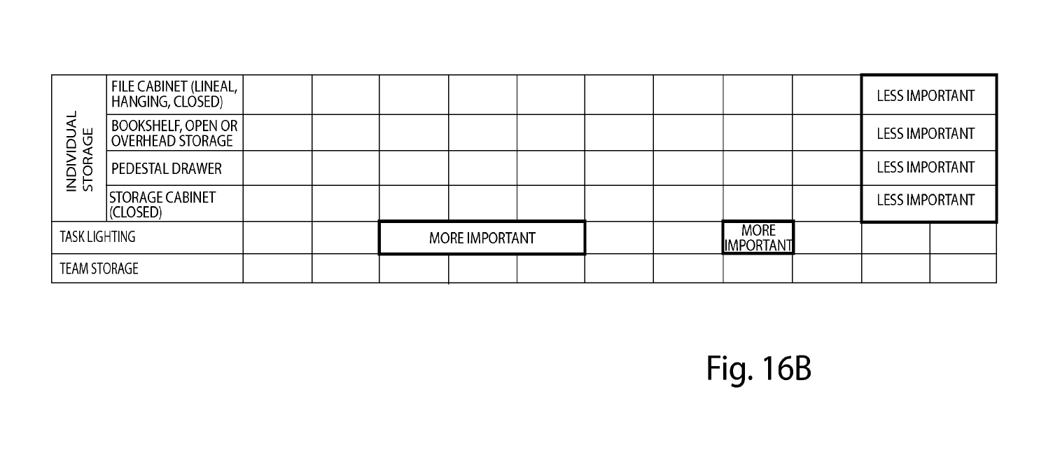

As an example of these concepts, FIG. 16 provides a table of the Design Implications versus the 8+3 Workstyles of the invention. The table includes columns and rows of boxes and has many empty boxes indicating that the Workstyles in and of themselves do not dictate a status identifier for the design implication associated with that box. For example, box 50 is blank which indicates that Workstyle #4 P+L+K−C−(See FIG. 8), which is in column 51 does not predetermine the design implication for the Infrastructure capability in row 52. However, in columns 54, 55 and 56, which correspond to L− Internal Mobile, L− External Mobile and L− Home Based (also referenced as Workstyles #9-11 in FIG. 8), the same row 52 for each Infrastructure capability is prefilled with “Low capacity”. This status identifier spans the boxes for all of columns 54-56 for this row 52.

It can be seen that a number of boxes have been prefilled with status identifiers simply due to the Workstyle type. In essence, some Design implications may be Workstyle dependent for that Workstyle. If there is no direct relationship, then the other boxes of FIG. 16 are left blank. These blank boxes then indicate that the design implications need to be calculated by the system 10 to determine the status identifiers for each design implication based on questions other than the ones directly linked with Workstyles. As noted above, the Workstyles in and of themselves do not dictate all the design implications. While some implications may be directly determined by a particular Workstyle as just described, many of the design implications factor in different information that is obtained by Questions other than those directly linked with the Workstyles such as questions Q2 and Q7-Q12. If new design categories were to be added to the invention, the survey questions would be evaluated to determine which survey questions were relevant to the new design category and then appropriate algorithms developed to calculate the design implications dictated by the survey data.

While the chart of FIG. 16 illustrates all of the design implications that would be associated with an individual, this individual data is preferably not used on an individual level to generate the Level II Output but instead is processed on the group level to which each individual belongs. These design implications at the group level provide more useful data for designers, who usually design work environment based on different group (such as department) needs.

Additionally, since the prefilled boxes are preassociated with certain related Workstyles/Design implications, these prefilled boxes also are applicable at the group level, such that FIG. 16 is applicable to each group of an organization. It is the unfilled boxes, once filled, that differentiate the design implications for the different groups. Further, prefilled boxes of FIG. 16 also remain the same from organization to organization, while the unfilled boxes will differ. This is a unique feature of the invention since known tools do not have the equivalent of these empty boxes. Rather, known systems mentioned previously in the Background section come up with 4-6 workstyles, and each have their own set of design implications, which are all the same across organizations and across industries.

In summary as to FIG. 16, certain Workstyles are considered to have common characteristics by the system 10 which predefines certain Design Implications, but does not define all of the remaining Design Implications. The following summarizes the common characteristics displayed by the filled boxes in FIG. 16. As mentioned above, an alternative naming convention, such as the one identified in Table 1, may be used to identify common characteristics of certain Workstyles.

Design Implications—Common Characteristics for Workstyle

1. P+L+K+C+

People in this category require a larger workspace area. While they also require an ergonomic task chair with higher level of adjustability, primary desk surface adjustability is less important for them.

2. P−L+K+C+

People in this category need a larger workspace area. They do not need writable vertical surfaces at their workstation, and the primary desk surface adjustability is less important for them. Also, they do not need a tertiary work surface or guest seating at their workspace; however, they do require an ergonomic task chair with higher level of adjustability.

3. P+L+K+C−

People in this category require a larger workspace area and the primary desk surface adjustability is also important for them. They also need an ergonomic task chair with higher level of adjustability, as well as task lighting at their desk.

4. P+L+K−C−

People in this category can have a smaller workspace area; however, primary work surface adjustability is important for them. It is also important for them to have an ergonomic task chair with higher level of adjustability. They also need task lighting at their desk.

5. P−L+K+C−

People in this category require a larger workspace area. They do not need writable vertical surfaces at their workspace. They also do not need a tertiary work surface or guest seating. However, primary desk surface adjustability and having an ergonomic task chair with higher level of adjustability is important for them, as well as task lighting at their desk.

6. P−L+K−C+

People in this category can have a smaller workspace area. They do not need writable vertical surfaces at their workspace, and primary desk surface adjustability is less important for them. They also do not need a tertiary work surface or guest seating. However, it is important for them to have an ergonomic task chair with higher level of adjustability.

7. P+L+K−C+

People in this category can have a smaller workspace area. Primary desk surface adjustability is less important for them; however, they require an ergonomic task chair with higher level of adjustability.

8. P−L+K−C−

People in this category can have a smaller workspace area. They do not need writable vertical surfaces, tertiary work surface, or guest seating at their workspace. However, primary desk surface adjustability is important for them. It is also important for them to have an ergonomic task chair with higher level of adjustability, as well as task lighting at their desk.

9. Internal Mobile

Workers in the internal mobile category are more mobile and less tethered to physical space. They could either have assigned workspaces or could share “touch down” spaces, where more than one internally mobile worker share one workspace. Other special characteristics (see below), such as storage needs, must be carefully considered, however.

People in this category can have a smaller workspace area. Their panels' infrastructure capability can be of lower capacity, since they mostly use mobile equipment. Primary desk surface adjustability is less important, and a task chair with lower adjustability is acceptable for them, since they spend less time sitting at their desk. They do not need a tertiary desk surface or guest seating at their workspace.

10. External Mobile

Workers in the external mobile category are the most mobile and least tethered to physical space, especially within the office. They might be good candidates for sharing workstations (touch-down or “hoteling”), however this should be carefully considered based on other special characteristics (see below), such as storage needs.

People in this category can have a smaller workspace area. Their panels' infrastructure capability can be of lower capacity, since they use mobile equipment. Primary desk surface adjustability is less important, and a task chair with lower adjustability is acceptable for them, since they spend less time sitting at their desk. They do not need a tertiary desk surface or guest seating at their workspace. Individual storage space is less important for them, especially when sharing workstations.

11. Home Based

Depending on how much time these workers spend working from home, providing an ergonomic and distraction-free workspace might become more important at home than at the office, and the employer should provide support. They might be good candidates for sharing workstations (drop-in) with others in the office, but the seat to headcount ratio should be carefully planned, and other special characteristics (see below), such as storage needs, must also be carefully considered.

People in this category can have a smaller workspace area. Their panels' infrastructure capability can be of lower capacity, since they use mobile equipment. Primary desk surface adjustability is less important, and a task chair with lower adjustability is acceptable for them, since they spend less time sitting at their desk. They do not need a tertiary desk surface or guest seating at their workspace. Individual storage space is less important for them, especially when sharing workstations.

As indicated in the top row of FIG. 16, the Internal Mobile workers may be provided with an assigned space or alternatively use a temporary touch down workspace. External Mobile workers typically would use touch down workspaces, while the least frequent visitors, namely the Home Based workers would only need drop-in workspaces. Whatever the situation is, it always depends on the organization on a case by case basis, and the designer would make the decision based on the data provided by this invention.

To better design these workspaces, the system 10 identifies the certain common design implications that depend upon the Workstyles. The system 10 then also uses the survey data to calculate and determine the remaining design implications represented by the unfilled boxes of FIG. 16. If the chart of FIG. 16 was used for each individual, each unfilled box ultimately would be filled in with one of the status identifiers for each of the design implications.

Essentially, the computer-based system 10 performs predetermined calculations for each design implication based upon the survey data in step 24 of FIGS. 1 and 2 and generates output level II which output level represents a complete identification of every design implication. This second level output is then stored for further processing below.

For the calculations of step 24, these calculations preferably represent a transformation of the survey data based upon the answers to the individual questions. In developing this process, it has been found that certain survey questions may be relevant, or at least be relatively significant, for some design implications yet be irrelevant or have minimal significance to other implications.

Hence, the algorithms performed in the computer processing of step 24 preferably are defined based upon the relevance of the survey questions to the individual design implications, wherein each design implication is determined with reference to the answers to one or more relevant questions.

For example, a determination needs to be made for the first design implication of the Layout category of FIG. 11A, or in other words, the position of the individual relative to traffic flow or circulation must be determined as being a high traffic preference, a low traffic preference, or if there is no preference, then either way. These are the three options seen in FIG. 11A. As to the relevant questions, Question 1 may be relevant since an Independent P− individual may prefer low traffic and an Interactive P+ individual may prefer high traffic. Similarly, Question 2 may be considered since at least some answers suggest preferences for high or low traffic. Also, Question 5 may be relevant since the traffic flow may impact an individual's ability to concentrate wherein the need to concentrate is the subject of this question. Lastly, Questions 10 and 11 address the exposure of the individual to confidential information, which therefore may suggest placement of an individual in low traffic areas. Generally, the answers to each relevant question may provide a suggestion of low traffic or high traffic, although not all possible answers need be considered. For example, in considering Questions 1 and 2, Answers 1.1 and 2.1 may be considered as suggesting “low traffic”, while answers A1.2 and A2.3 might suggest “high traffic”. Other answers for these questions might be considered as being generally neutral and default to “either way.” In another example, it seems likely that for answer A5.1 of Question 5, which indicates that the individual always concentrates intensely and should never be distracted, one would conclude that this answer would suggest “low traffic.” Remaining answers A5.2-A5.4 may then simply indicate “either way” although A5.2 might also be used to suggest “low traffic” depending upon how the system is calibrated.

Ultimately, one or more answers to each relevant question are included within logical expressions to determine either “high traffic”, “low traffic” or possibly default to “either way”. If multiple questions are considered, multiple indications may be determined. This calculation may then result in different quantities of each status identifier wherein the calculation step 24 may then perform a comparison of the quantity in order to select one identifier as being appropriate. For example, the sum or total number of high traffic and low traffic results for the single design implication may be less than the total of “either way” wherein “either way” would be the design implication. If the sum is not less than, the greater of high traffic or low traffic would be selected. Hence, by consideration of the answers to the relevant questions, the design implication of “Position relative to circulation” would be only one of high traffic, low traffic or either way for the particular individual whose data was being evaluated.

Generally, similar calculations would be performed for each design implication for a particular individual, such that each box in the rightmost vertical column of FIG. 11A essentially would have a status identifier calculated for each design implication for that one individual. This data would be stored at the individual level for each person surveyed so that multiple individuals would create multiple data sets that would be stored for further processing at the group level as described below.

Therefore, the system 10 processes the survey data to perform a conversion step as part of step 24 which converts the survey data into individual design implications for each individual. The system 10 preferably comprises predefined algorithms or equations for such conversion step, wherein these equations are developed based upon the relevance of the survey questions and answers to a particular design implication. Not all questions and not all answers are necessarily relevant to each design implication, and each equation for any question can be weighted to better differentiate the range of design implications. These equations are pre-set in the system and are updated periodically when data is accumulated over time. The more data the system accumulates over time, the more precise this “calibration” can become.

For example, it may be found that the relevant questions for a design implication still generate a strong preference for one possible design implication that also shows for all groups. This may place unnecessary emphasis on one status identifier for the design implication, and the preset equations may then be adjusted or weighted to calibrate the results in a manner that provides a more equal distribution of the multiple status identifiers for that design implication. For example, if too many individuals are found to have workspace design implications for low traffic areas, it may not make sense in relative terms if there is no high traffic area design implications, so there is nothing to compare the former with. There might also be physical limitations: it might not be possible to physically accommodate this number of people in low traffic areas and the value of the design implication falls. Thus, it may be necessary to weight the relevant questions and answers to better identify those individuals who have a more critical need for location in a low traffic area. This is accomplished by modifying or calibrating the equations used in the processing step to create a better balance of High and Low traffic conclusions.

Typically, each design implication will be associated with its own unique set of relevant questions. For example, when considering the “infrastructure capability” of the Enclosure category, one might only consider Question 3 as to whether individuals are fixed in Place and Question 12 which is the identification of the total number of electrical devices. In this regard, if an individual has a fixed location and has a large enough number of electrical devices, they may end up with High Infrastructure Capability. However, mobile workers or fixed individuals with a low enough number of electrical devices likely would only need Low Infrastructure Capability.

For the Writable Vertical Surface implication, the only relevant questions might be Question 1 as to whether the person has frequent face-to-face interactions, and Question 2 as to whether the person collaborates within the person's groups. If they do not collaborate, or only collaborate in other office areas, there may be no need for this writing surface.

Hence, for each design implication, a set of relevant survey questions and answers or answer combinations are assigned thereto, and then equations are developed for each implication to transform the survey question data into an individual design implication represented by only one of the status identifiers associated therewith. If desired, an individual's design implications might be shown by the table of FIG. 11A wherein the third column showing the available status identifiers would only show the one identifier calculated for the associated design implication for the individual. This table would be similar to FIG. 11B which applies to group level data with the only difference being the rightmost column wherein all status identifiers would have a common font and equal weight. The different fonts used at the group level in FIG. 11B are described below.

So far, it has been explained how the system transforms individual survey data into individual design implications using built in algorithms/equations. Individual design implications, however, as already stated above, are not much use for designers who usually design office spaces on the group level. So as a next step, all of the individual data are then transformed by the system into the group data for each group of the organization. As stated earlier, users of this system can freely define different groups as per based on departmental or other demographic (such as job type or job level) information. For example, a particular group may have 23 survey respondents, whereby the individual data sets for these 23 respondents must then be transformed into a single set of group data, such as is shown in FIG. 11B. The initial calculation for converting the individual data to group data preferably involves summing the quantity of each status identifier for a design implication and then comparing the quantities wherein the highest quantity would determine the design implication.

For example, when considering the design implication “Team Storage,” 20 individuals might have status indicators as “Less important,” while 3 individuals might have this as “More important.” In this instance, the Design Implication for Team Storage for this group is determined to be Less important, as can be seen on FIG. 11B, based on the majority.

With a majority of 20 to 3, that is, 20 Less important and 3 More important, the system would have a high level of confidence that this Design Implication should be set to Less important on the group level. This is based on the simple assumption that if the designer would specify team storage as Less important for this group, 20 individuals of the group's population would be “satisfied,” that is, the majority of them. However, if the numbers were more equal, such as 13 to 10, “Less important” would still be the final determination for the group level but the confidence level that this is the correct design implication for the group would be less due to the smaller difference. To address this consideration, the system 10 not only makes a determination as to the Design Implication in the data, but also indicates a degree or level of confidence in the Design Implication.

In this regard, the preferred system uses four levels of confidence measured as high, medium, and low levels of confidence, as well as zero or no confidence. Referring to FIG. 11B, the four levels of confidence are represented by four different indications or indicia, which may take any readily-distinguishable form besides the preferred form disclosed hereafter. As preferably seen in FIG. 11B, a high level of confidence is indicated by displaying the Design Implication in bold font, such as the “Less important” for Team Storage. A medium level of confidence is displayed by the regular weight font (also called “plain” font), such as the “More important” shown for the “Pedestal drawer” implication of Individual Storage. A low level of confidence is displayed by the faded or grey weight font, such as the “Higher” shown for the Task chair level of adjustability. To clearly indicate this lighter weight font, this font is shown with an asterisk (*) for illustrative purposes of this application. The asterisk preferably is not used in the system 10. Where the level of confidence is zero (i.e., there is no confidence in the results), it means an exact break even, where exactly half of the population falls into one status indicator (such as More important), and the other half falls into the other opposite indicator (Less important), so the level of confidence of which design implication would satisfy the entire group better is zero. This implicitly also means that no matter which status indicator the designer would consider, half of the population would be supported, and the other half would not be supported with the results. In such cases, a Design Implication status indicator may not be displayed at all, that is, only an empty box would be shown as seen for the Bookshelf of Individual Storage in FIG. 11B. In such instances, the user could further subdivide the data set into subgroups to try to see how these zero confidence design implications might be divided among subgroups on a more confident level.

The use of different fonts is one preferred display the system may use. It will be understood that other indicia may be used such as different font colors, secondary indicia added to a standard font, or the like.

To determine the level of confidence, the system 10 determines the actual percentage of individuals associated with each possible status identifier for a Design Implication. In the next example, for the sake of easier calculations, the group discussed above is modified so that it only has 10 individuals. If all 10 individuals or 100% of the group has the Team Storage status indicator to be “Less important”, this would be a majority percentage (i.e., 100%) and would provide the highest level of confidence as shown. On a 0-10 scale, this would be a 10. If the workers were split 5 to 5 wherein the actual percentage was equally split 50% between More and Less, this would provide no level of confidence and be a 0 on the 0-10 scale. To illustrate these concepts, FIG. 11C is provided showing confidence range, confidence percentage and actual percentage. There would not be an actual % less than 50% since this would simply reverse the numbers wherein “Less important” would be the majority percentage instead of “More important”.

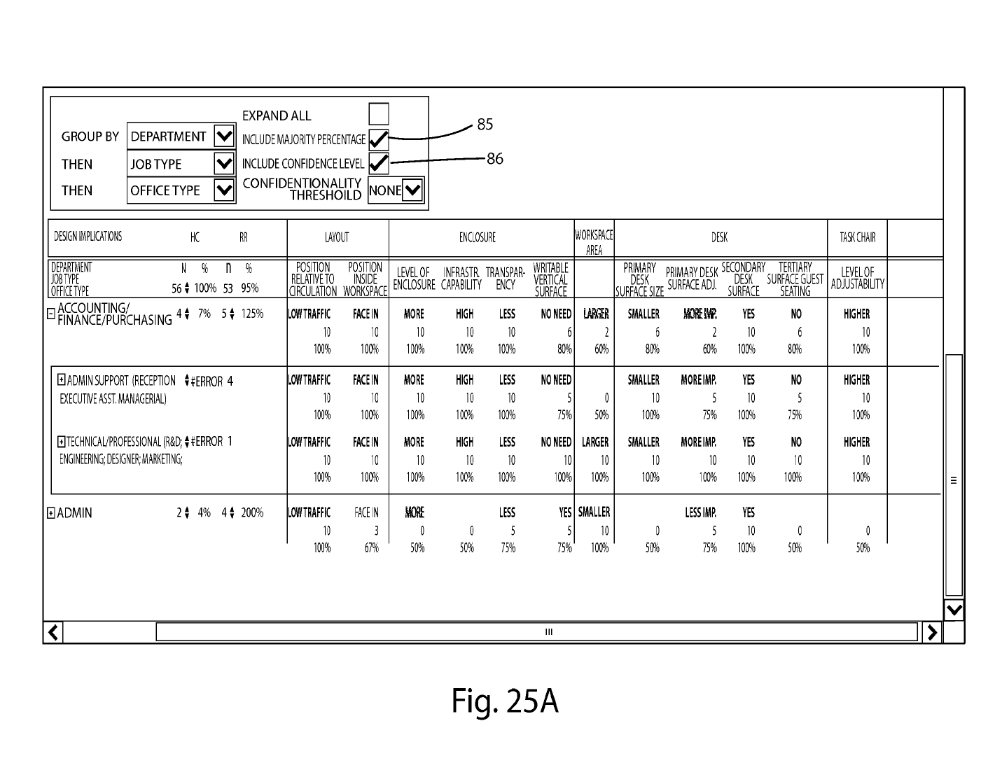

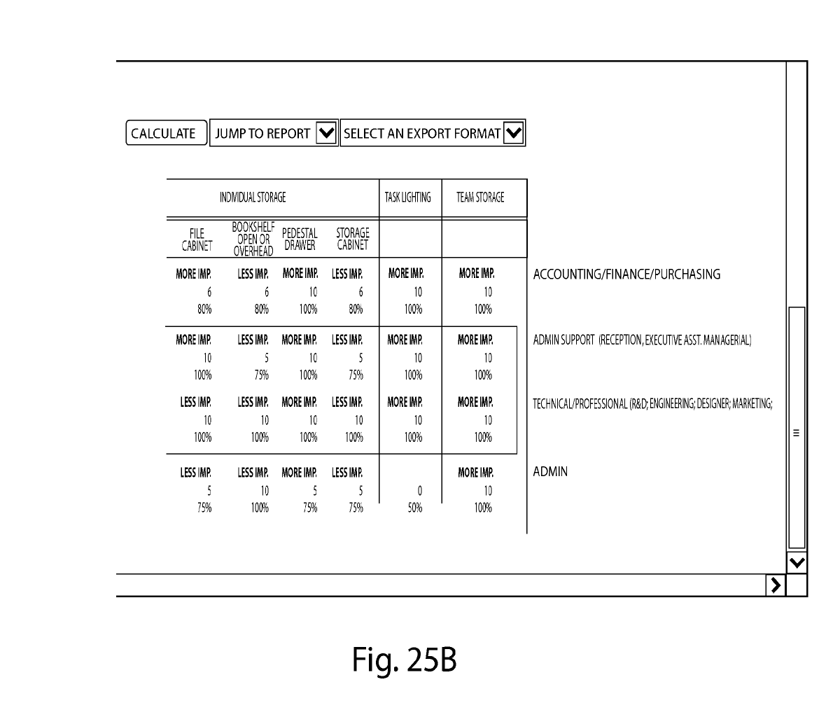

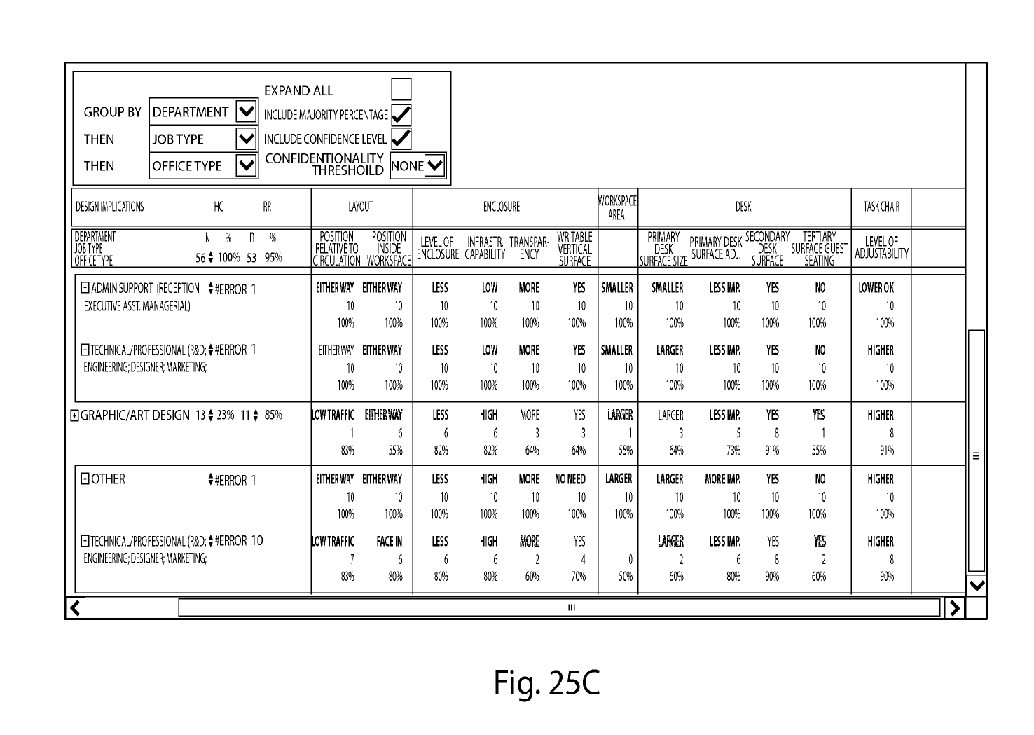

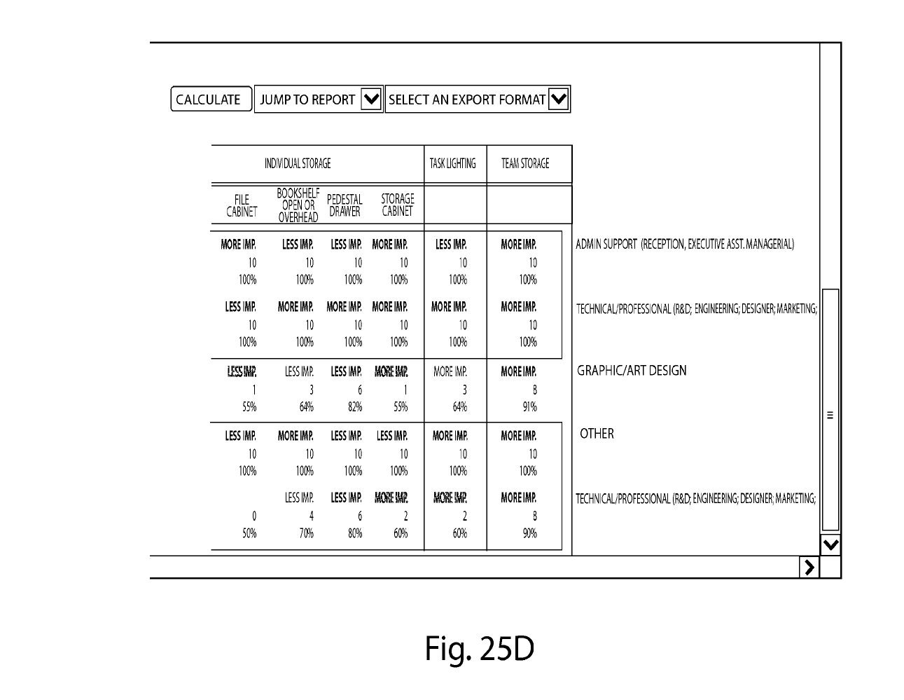

In between the limits of 0 and 10 or in other words 50% and 100%, the confidence levels would progressively increase with the majority percentage. Preferably, a majority percentage greater than 50% up to 60% would provide a scaled confidence of 1 or 2 (corresponding to 55% and 60% actual percentages, respectively) and would be represented by the faded/gray font indicating a low level of confidence. A majority percentage greater than 60% up to 70% would provide a scaled confidence of 3 or 4 (actual population percentages of 65% and 70% respectively) and would be represented by the normal or “plain” font indicating a medium level of confidence. Lastly, any majority percentage greater than 70% would provide a scaled confidence of 5 to 10 and would be represented by the bold font indicating a high level of confidence. FIG. 11B therefore shows the Design Implication calculated at the Group Level, but also the confidence level in each Design Implication. The above percentages and confidence levels are just one example the system might use, but other percentage and/or confidence levels might be used by the system, if needed. The system preferably displays either the confidence range levels 0-10, or the actual percentages 50%-100%, or both, as set by the user (see FIG. 25B described below).

If any group is broken down into sub-groups, this same system is simultaneously showing the Design Implications and the confidence levels and/or the actual percentages can continue to be used, simply by calculating the data for those individuals making up the sub-group. It will be understood that the groups may comprise any number of people from as small as one to any greater number. However, group of one is usually not displayed due to confidentiality issues (anonymity is usually promised to respondents in order to elicit a more honest response).

In this manner, the survey data is converted into a format that is readily usable by third parties in designing the actual physical workspaces.

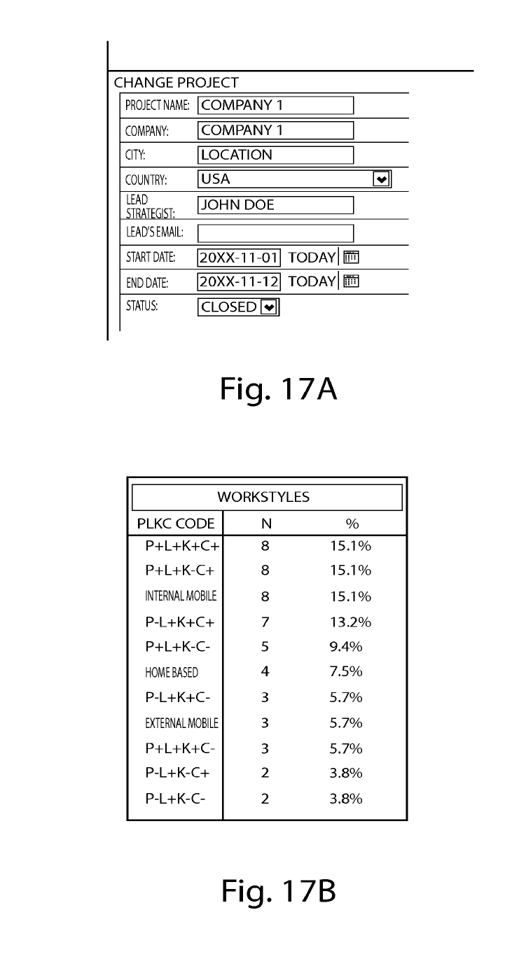

Referring to remaining FIGS. 17-26, the system 10 preferably is a computer-based interface or application that allows for visual display of numerous data display formats and the production of reports showing the system results.

The system and method of the invention preferably performs the survey and data collection on behalf of multiple companies or organizations. While the results are generated based upon the specific data collected for each organization, the system 10 is able to store the data and results for multiple organizations.

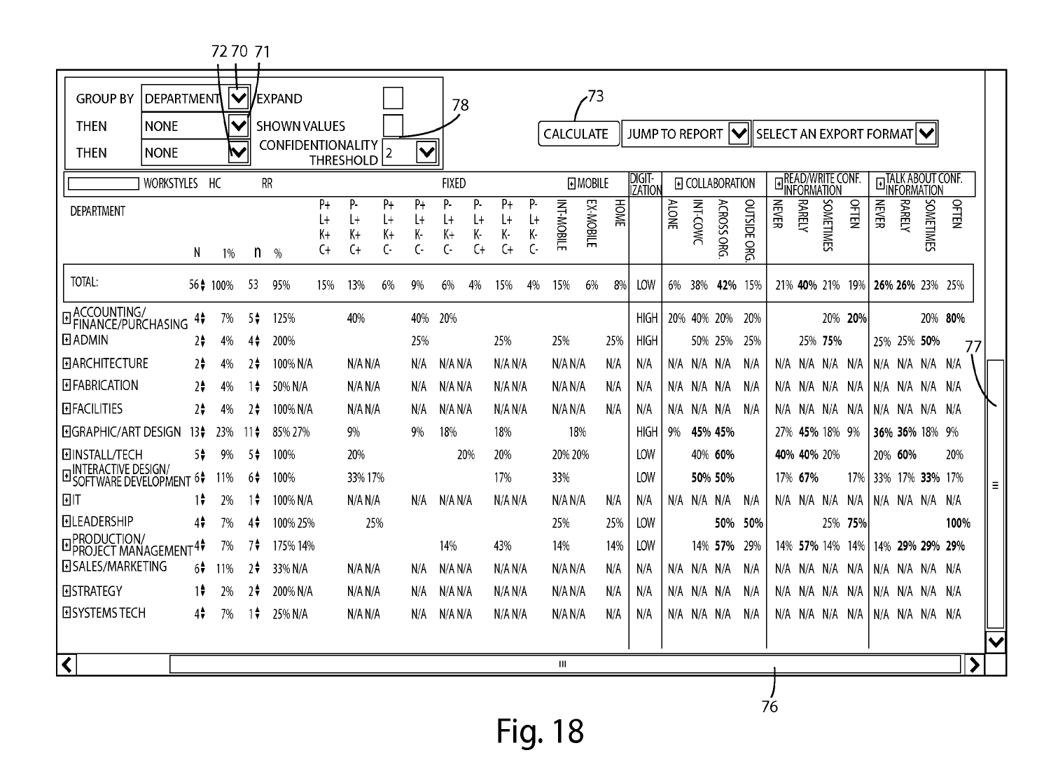

FIG. 17A is an initial screen wherein the data for a particular project is initially inputted through input boxes for Project Name and Company. Upon calling up the project data, the table of FIG. 17B may be displayed showing the overall percentage breakdown for each Workstyle found in that particular company, in descending order. The number of individuals per each Workstyle is also shown under Column “N.” On this screen, a preferred more visual representation of the same data would be similar to the one illustrated on FIG. 4C. This screen then moves to the data display panel shown in FIGS. 18A-D.

These figures show a first format for displaying the project data, wherein the format can be varied by three levels of filters 70, 71 and 72. These filters 70 to 72 provide a common drop down list, which comprises demographical data filters, such as Department, Job Type, Job Level, Office Type, Age, Generation and Gender. The results may be filtered using only one filter 70 or all three filters 72 to provide different levels of detail. To effect any change to the displayed results, the Calculate button 73 is clicked by a mouse or the like.

The display format of FIGS. 18A-D shows the Department in the left column of FIG. 18A, Headcount (HC) information (N=number of people in each department; %=percentage of the number of each department as part of the whole organization), the Response Rate (RR) information (n=number of survey respondents for each department; %=actual response rate calculated by the headcount of each department and the number of survey respondents of same department). The top row shows aggregated numbers for all departments, that is, totals for the whole company or organization, and is highlighted. To the right, the Fixed and Mobile Workstyles are then shown which were determined through survey questions Q1, Q3-4, Q5 and Q6. FIG. 18B also includes columns for Digitization as determined by question Q7, Collaboration as determined by question Q2, and columns for the confidential information corresponding respectively to questions Q10 and Q11. Such information might be useful for the users of this invention as supportive information to Workstyles. FIGS. 18A-D respectively show the upper left and right and lower left and right corners of the table which are viewed by movement of the horizontal and vertical scroll bars 76 and 77.

This table shows the percentages of individuals for the entire organization and the individual departments. First the Workstyles columns show the percentages of individuals associated with the 8+3 Workstyles. The Digitization column shows the level of digitization for each department, calculated by averaging individual answers to Question 7. The Collaboration and Confidential Information columns show the percentages selecting the particular survey answer. For example, as to how often individuals Talk About Confidential Information, 26% answered Never, 26% Rarely, 23% Sometimes and 25% Often, totaling to 100%. These percentages are for the entire company, while percentages also are broken down for the different Departments in the Department rows, always totaling to 100% by each department.

It is customary to promise anonymity to survey participants in order to elicit more honest answers. However, in some cases, even though an individual's name is not displayed in the system, the system user could track down an individual's identity in a small enough sub-sample by looking at demographic data. For example, in a group of 5 people, where only 1 of them is a female, filtering said group by gender would clearly disclose the identity of the female respondent. To help preserve anonymity of individuals, a Confidentiality Threshold 78 is provided in a drop down menu allowing the selection of a numeral from 0 or None up to 5, or preferably even higher. In FIG. 18A, the threshold is set at 2. As a result, any department, group, or subgroup (the result of any combination of filtering by filters 70-72) with 2 or fewer members will no longer show the specific survey results, and instead only displays N/A or not available in the appropriate data locations. The higher the confidentiality threshold is set, the more “protection” it provides to preserve individual anonymity. The threshold also could be set to 0 or None to show all data, even for subgroups of 1 individual.

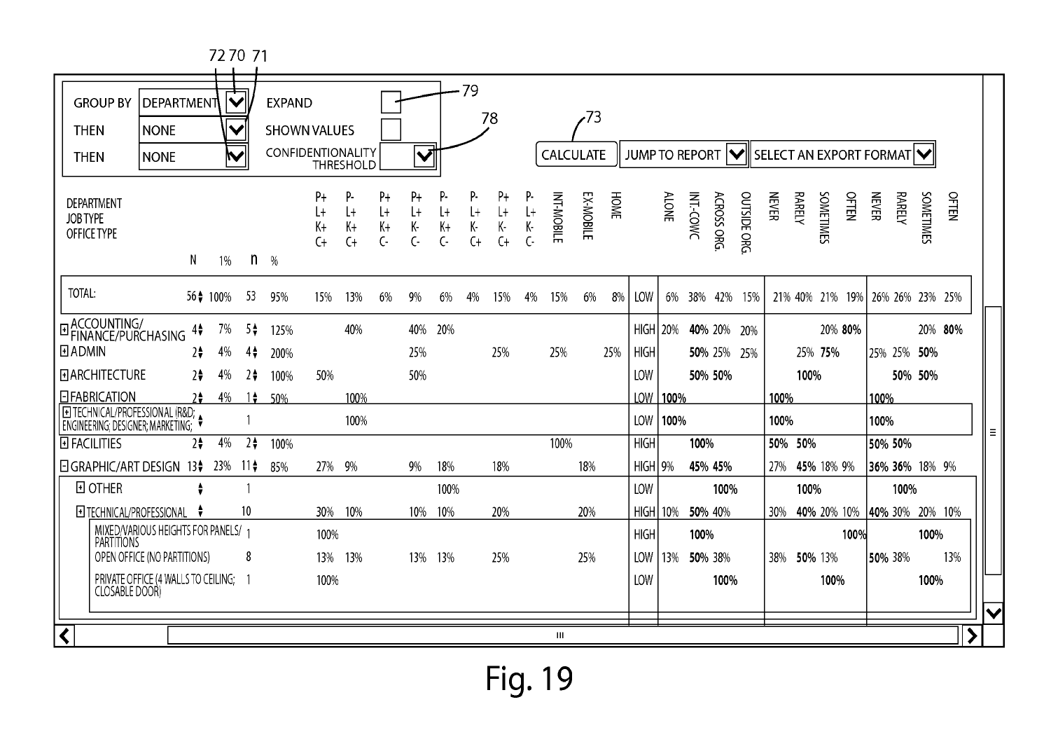

Referring to FIGS. 19A and 19B, an alternate display format is shown wherein the filter 70-72 are set to filter by department in filter 70, job type in filter 71, and office type in filter 72. The confidentiality threshold 78 is set to none so as to show all available data. In this report, the same general data is displayed at the department level but also additional data is displayed at the job type level and further broken down by the office type as desired. FIGS. 19A and 19B not only show the Job Type rows, but clicking on the plus signs also displays Office Type data in subsequent rows. This is permitted by use of the three filters. Alternatively, a user could just check “expand all” in the top menu, hit calculate, and all rows on three filter levels would expand. This data can be expanded or collapsed by clicking on the plus or minus box next to the department name or the job type or office type being displayed. This therefore allows the user of the system 10 to further evaluate the data that has been collected.

Alternatively, the user could check the box “expand all” 79 in the top menu bar, then hit Calculate 73, and the system would expand all rows to display all subsequent rows as filtered by the pre-set filters (70-72). This is a convenience function, so that the user does not have to expand each row by manually clicking on the plus signs. Similarly, the user can uncheck the “expand all” button, and after hitting the Calculate button, the system would only display the data on the first filter level (Department on FIG. 19A).

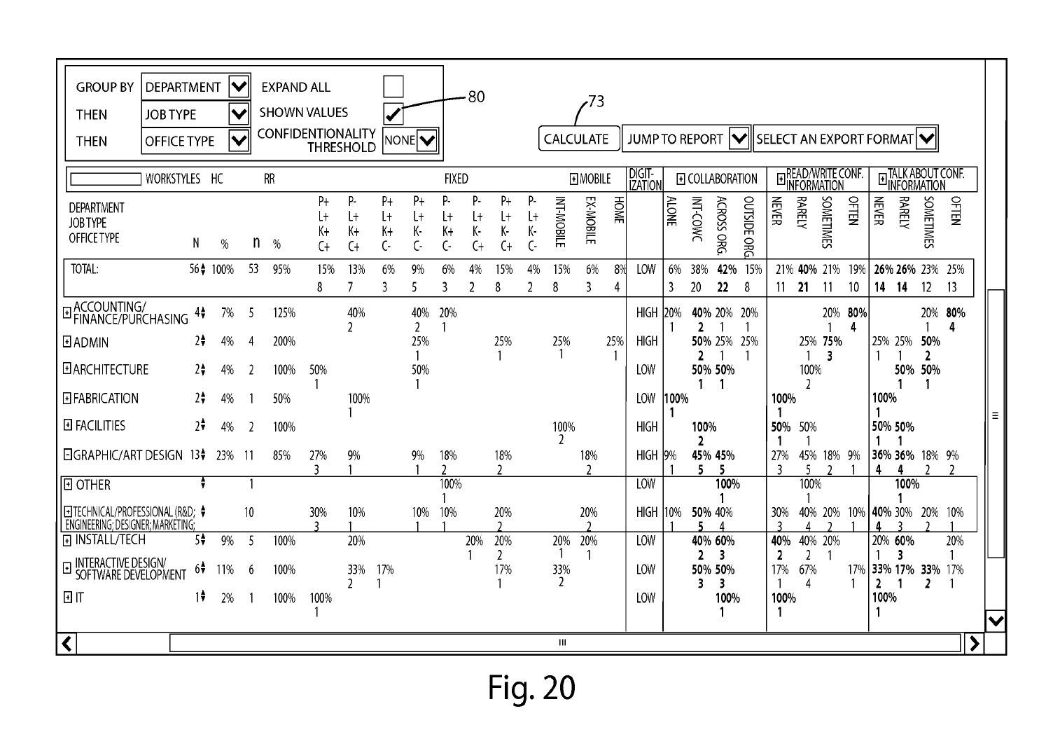

FIGS. 20A and 20B further displays additional data by clicking the checkbox 80 associated with n values which shows the raw quantities of survey respondents in each category that have been collected and used to determine the percentages shown in the prior display formats. After clicking the checkbox 80, the calculate button 73 would then be clicked to reformat the display. FIGS. 20C and 20D show the same display format except they have been scrolled down farther into the table.

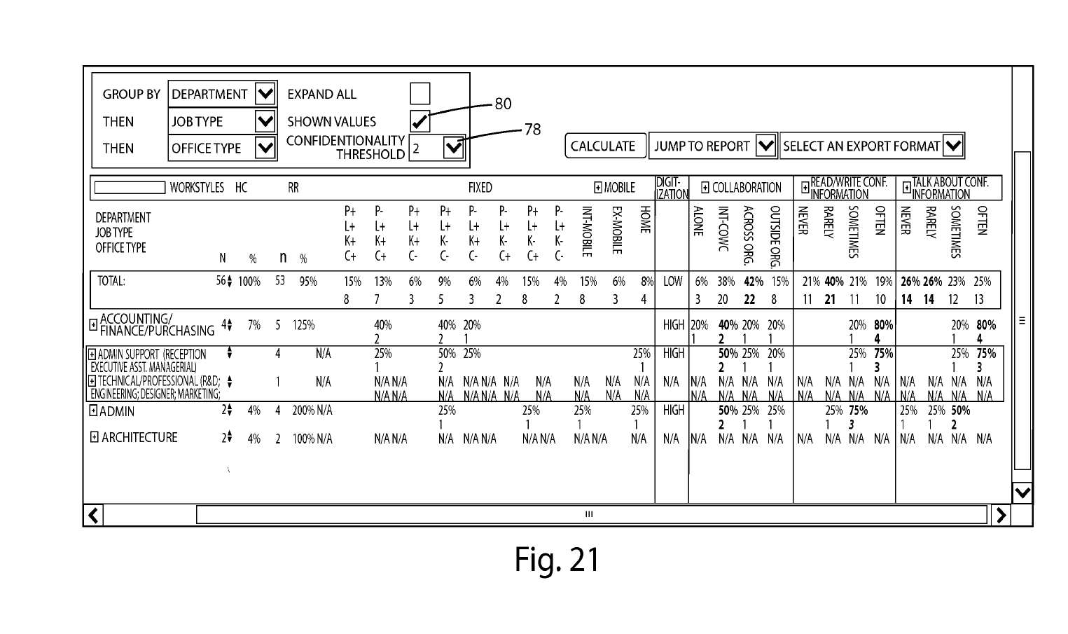

FIGS. 21A and 21B display the table format after such has been modified by the confidentiality threshold to 2 from none. This therefore hides certain data with those departments or subgroups that do not meet the minimum confidentiality threshold, i.e. those having 2 or fewer survey respondents.

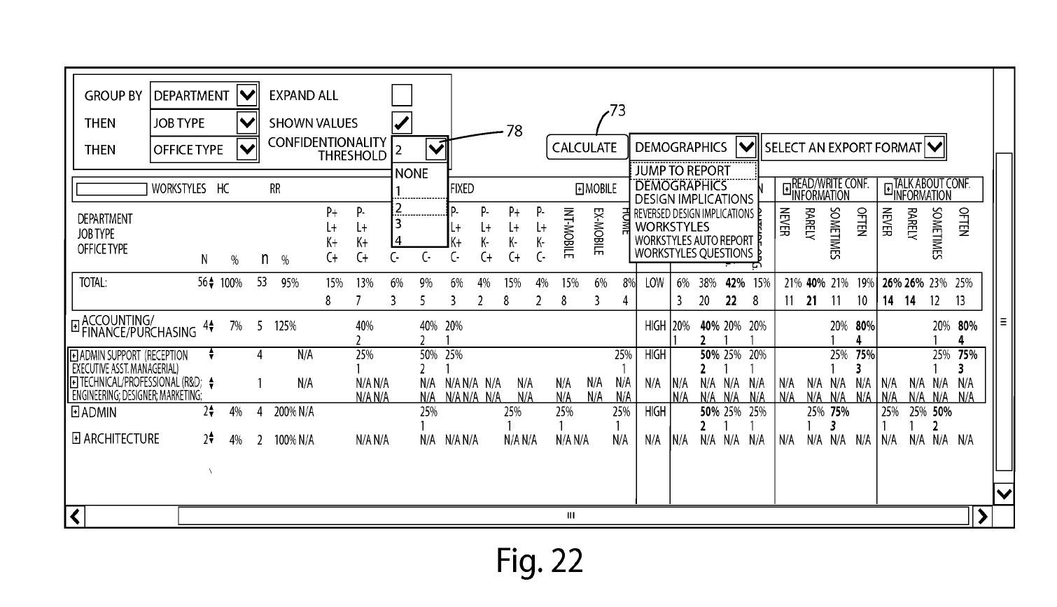

FIG. 22A shows the drop-down menu for the confidentiality threshold with the options ranging from none or zero to 5. Next, FIG. 22B illustrates the drop-down menu that allows for generation of reports and additional data. This drop-down menu allows the user to select any one of the options of jump to any of the following “reports:” demographics, design implications, reversed design implications, workstyles, workstyles auto report and workstyles questions. For example, design implications might be selected from this menu and then the display is reformatted to show a report on design implications.

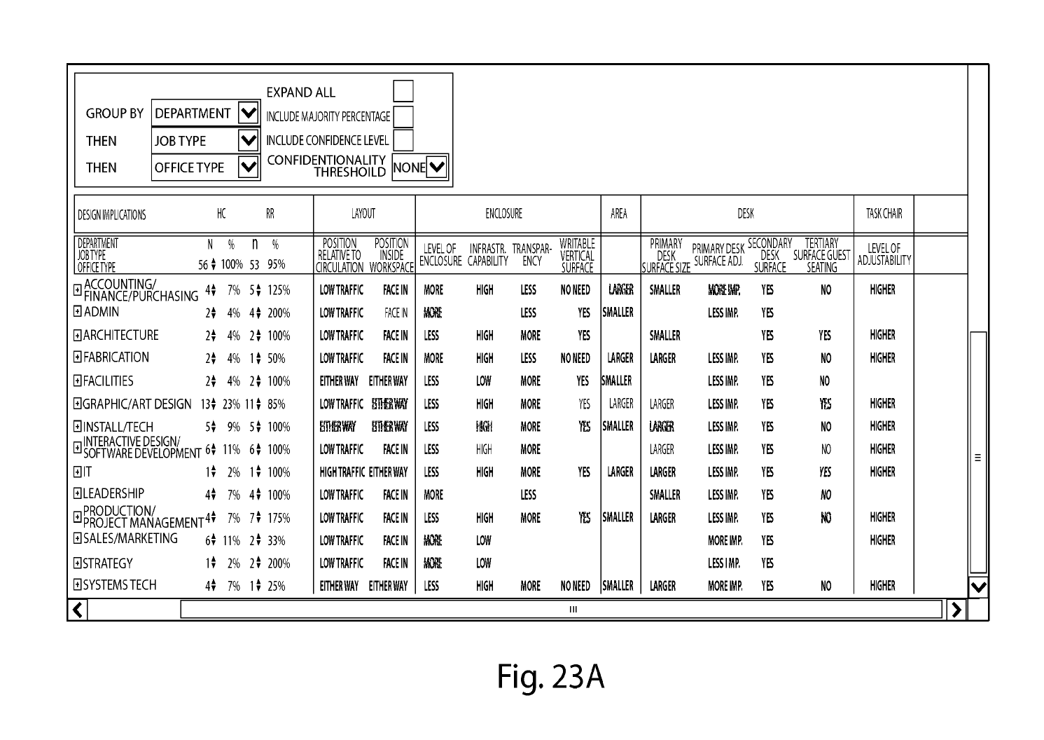

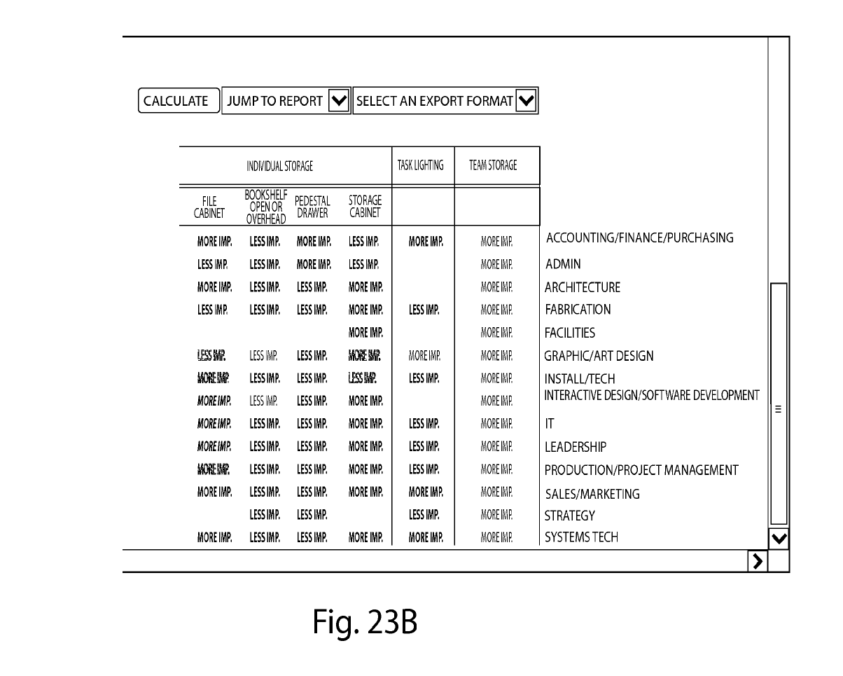

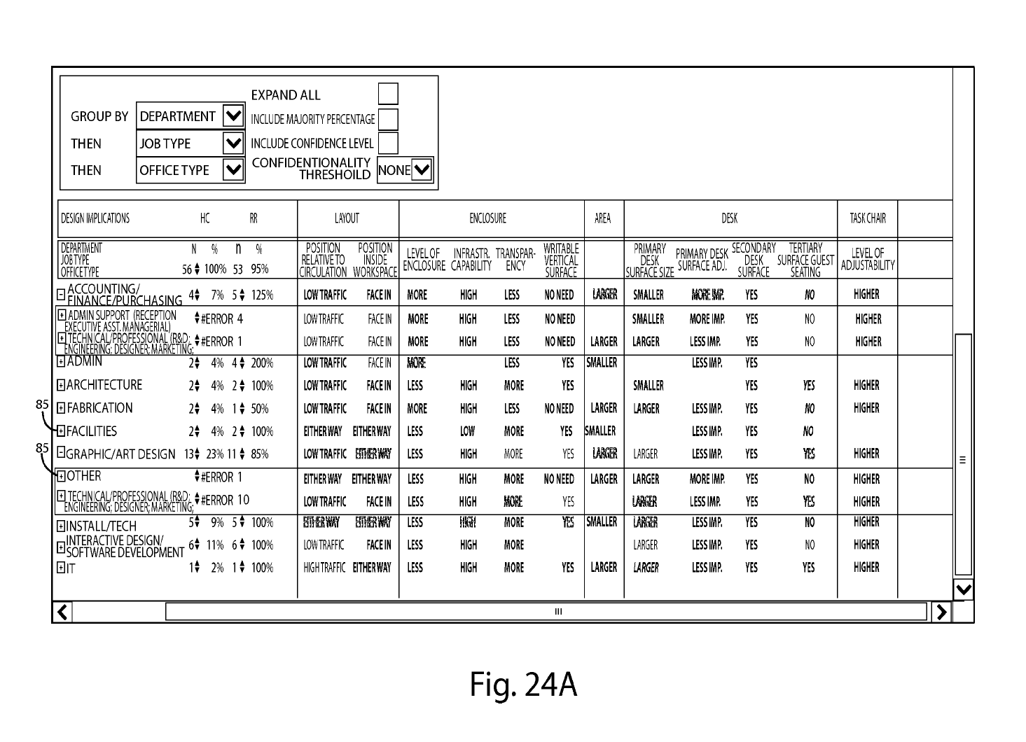

FIGS. 23A and 23B show the design implications display format showing the various design implications for the individual departments. In this regard, the table of FIG. 11B can be essentially displayed in one horizontal row since there is a column for each one of the design implications, and a row for each department wherein the row shows the particular status identifier determined for that department in that design implication. Further, the same system of confidence level is used in these displays through the use of different weight fonts or the showing of a blank box.

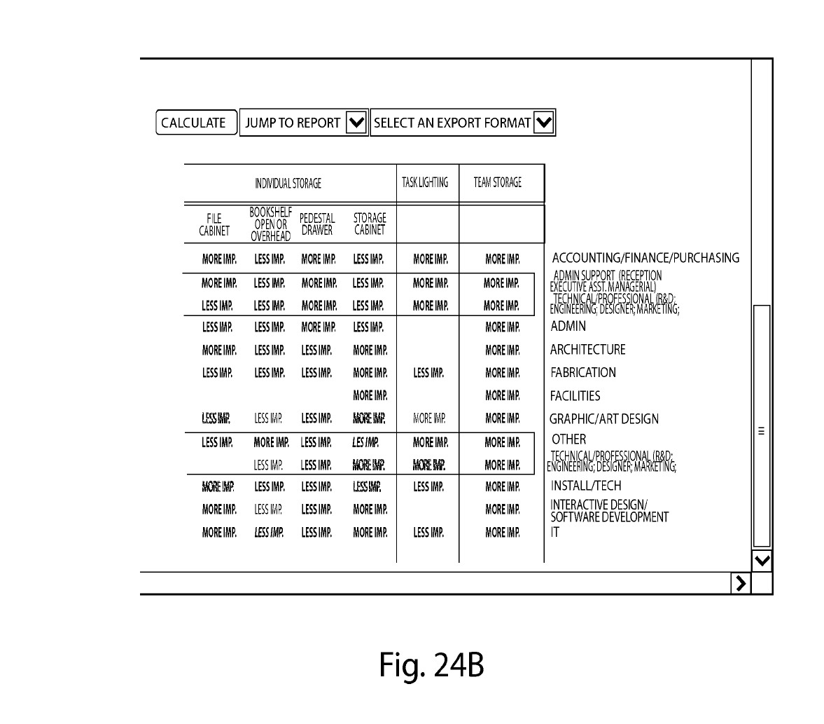

Referring to FIGS. 24A and 24B, these design implications may also be displayed according to subgroups set up by selecting the appropriate filters (70-72) from the roll-down menus and then by clicking on the Calculate button. FIGS. 24A and B show a filtering by Department, then Job type, then Office type. The user then can expand the department rows to show such filtered information by clicking on the plus button 85 next to a particular department. Since the confidentiality threshold is set to none, all available data is displayed, although it is also possible to block data if the confidentiality threshold is raised as previously described.

Referring to FIGS. 25A-25D, further information may be displayed by including both the majority percentage (ranging from 50% to 100% as previously explained) which is turned on by the checkbox 85 associated with the include majority percentage option. Also, the confidence level on the 0 to 10 scale can also be included by clicking checkbox 86. Thus, a user does not need to simply rely upon the different types of indicators, but can also look at the specific data supporting the confidence level including the majority percentage calculated for each of the departments and each of the subgroups.

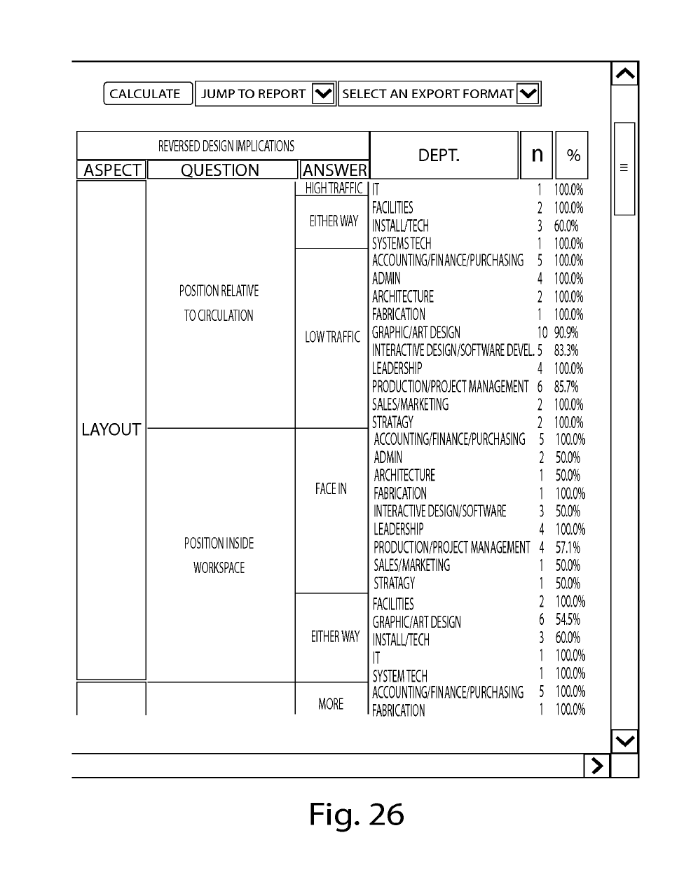

FIGS. 26A and 26B illustrate a portion of the additional option for showing the Reversed Design Implications. This changes the format into a vertically oriented table wherein the left two columns now display the design implication categories as well as the specific design implications in a manner similar to FIG. 11A. Additionally, each of the potential status identifiers or design oppositions is also shown in the third column from the left such as high traffic, either way and low traffic that are associated with the position of the individual relative to circulation. In the fourth column from the right of this report, the departments associated with each of the status identifiers are then vertically listed so that it can be determined which departments have workspaces that should be on high traffic, which departments can go either way, and which departments have workspaces that should be on low traffic. Additional columns (the rightmost two columns) are provided for the actual number of survey respondents (n) at each department that falls into each status indicator, as well as the percentage they represent within the total survey respondents in that department.

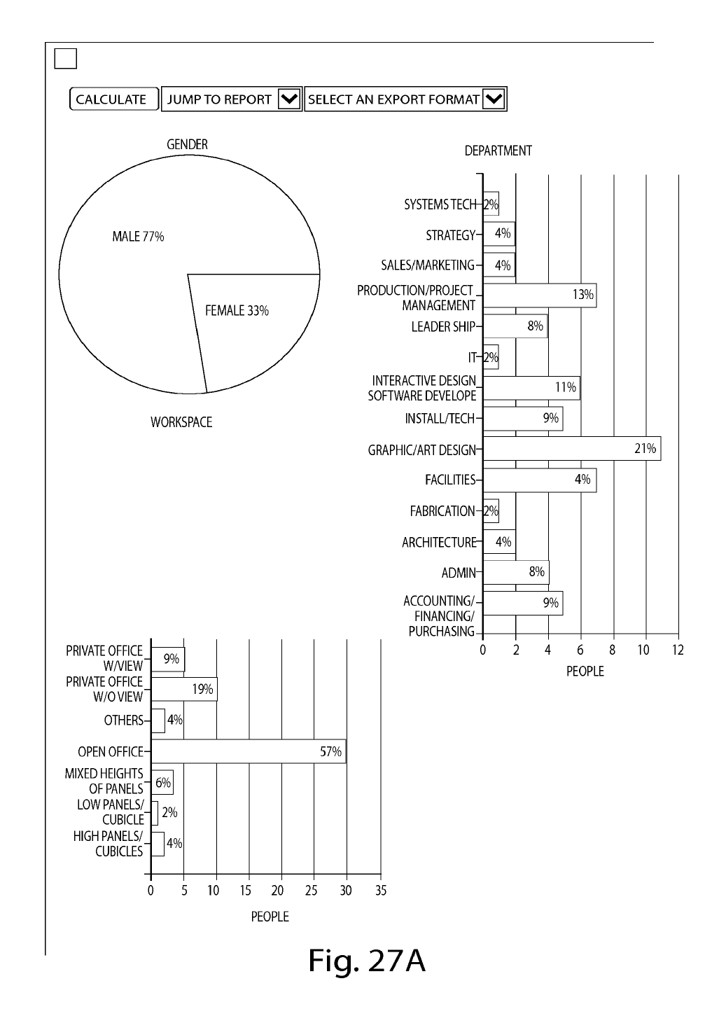

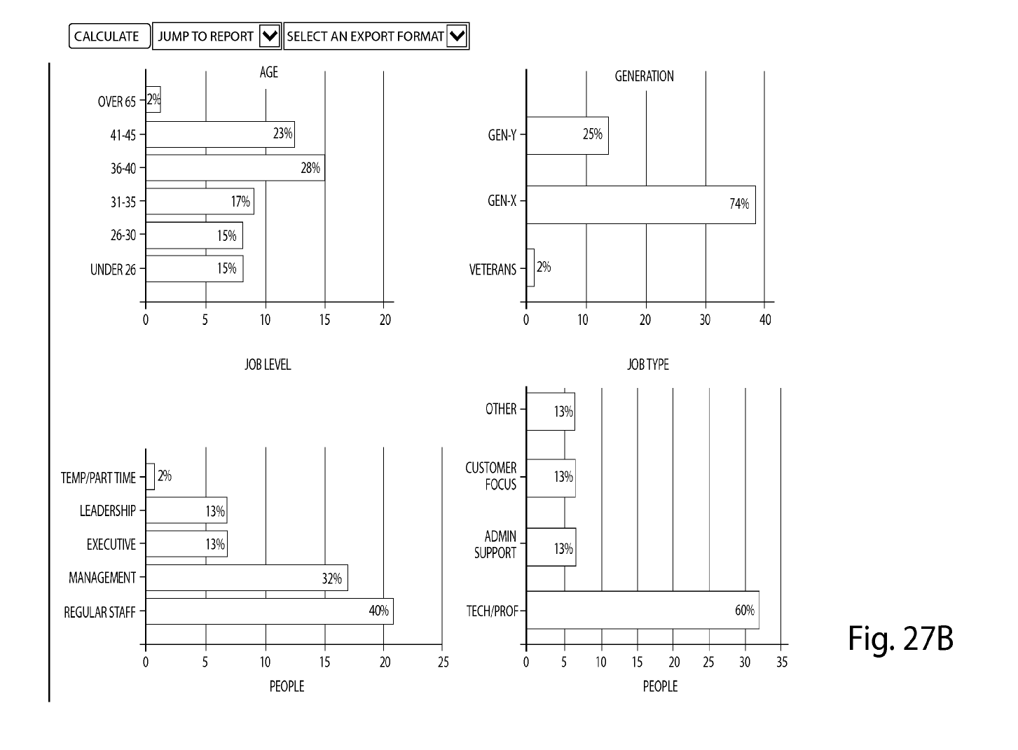

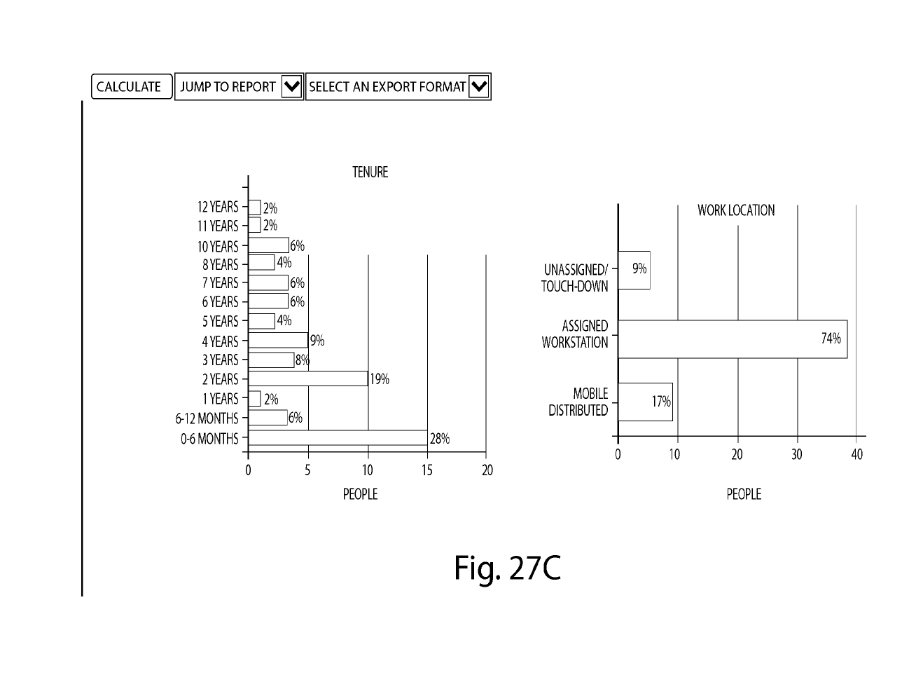

The above-described display formats represent the most significant display formats associated with the invention. Besides these, it is also possible to view the data according to the demographics preferably in bar and pie chart formats, or whatever the user prefers and selects from a possible menu of graph formats. FIGS. 27A-27E illustrate multiple screen shots of a demographic report, which are presented on a single screen and are viewed by scrolling vertically through the screen. FIG. 27A illustrates a pie chart for the gender breakdown and a bar graph for the department breakdown. FIG. 27B illustrates a continuation of the department bar graph, as well as a graph of the workspace features (or “office type”). FIG. 27C illustrates tables for age and generation; FIG. 27D includes tables for job level and job type; and FIG. 27E includes bar graphs for tenure and work location. In this manner, a report can be generated showing the demographic data collected with the surveys. Additionally, these reports can then be exported into any of the usually available formats such as Word, Excel, PDF or any other desired format that might be provided.

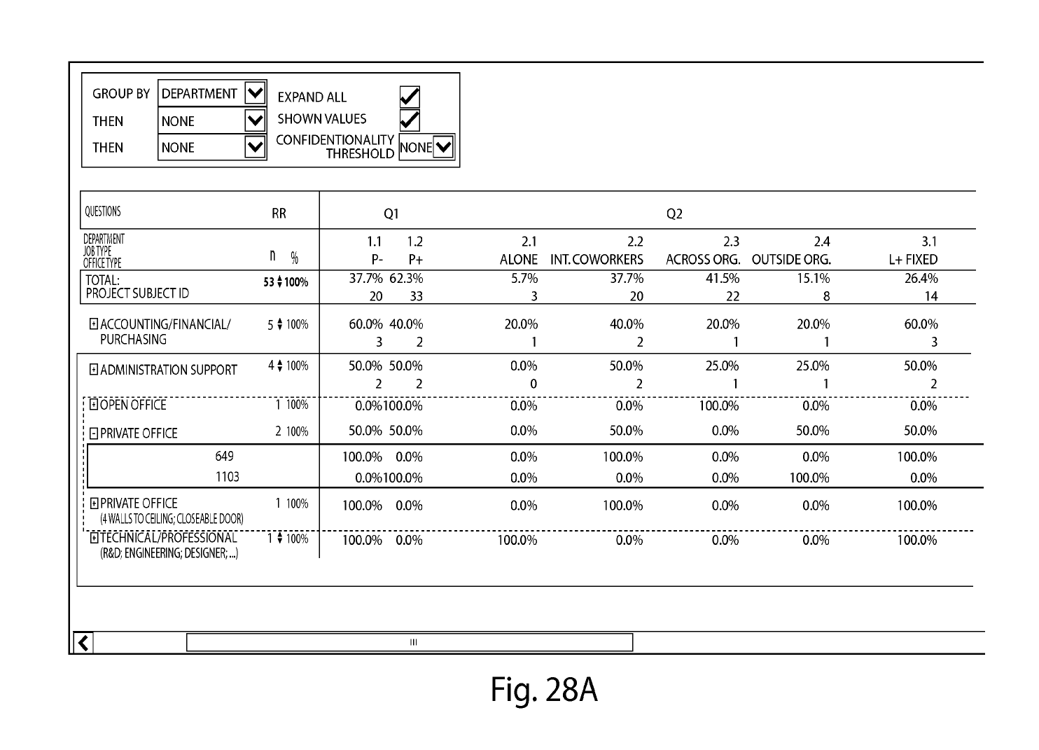

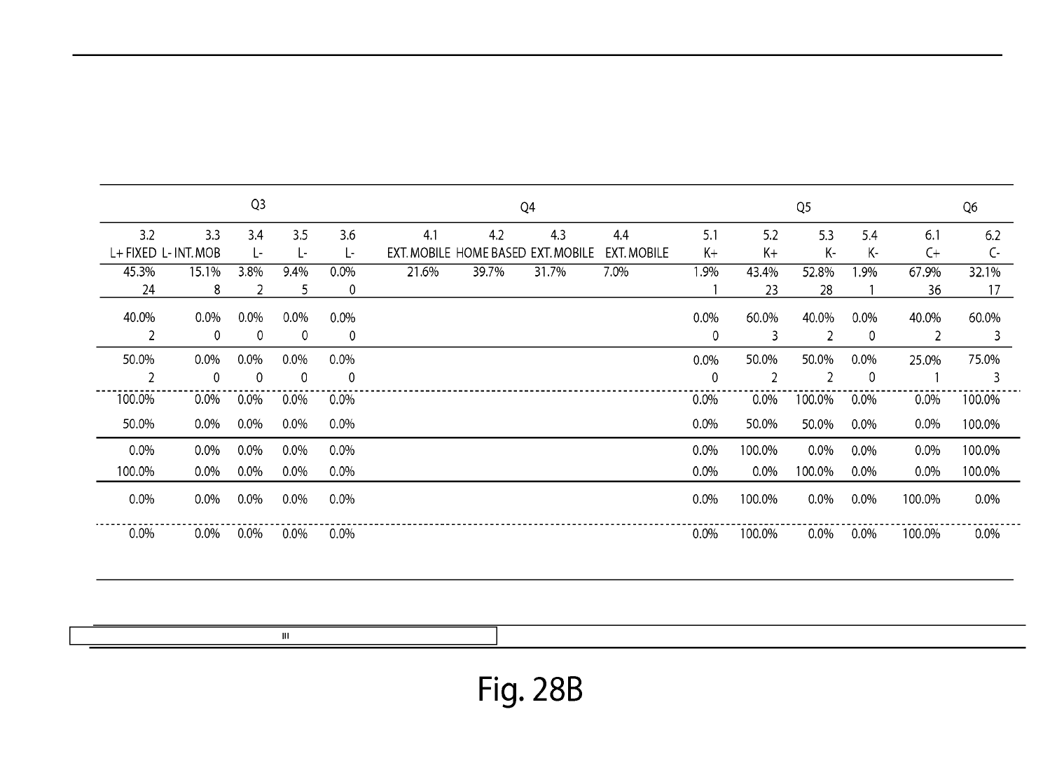

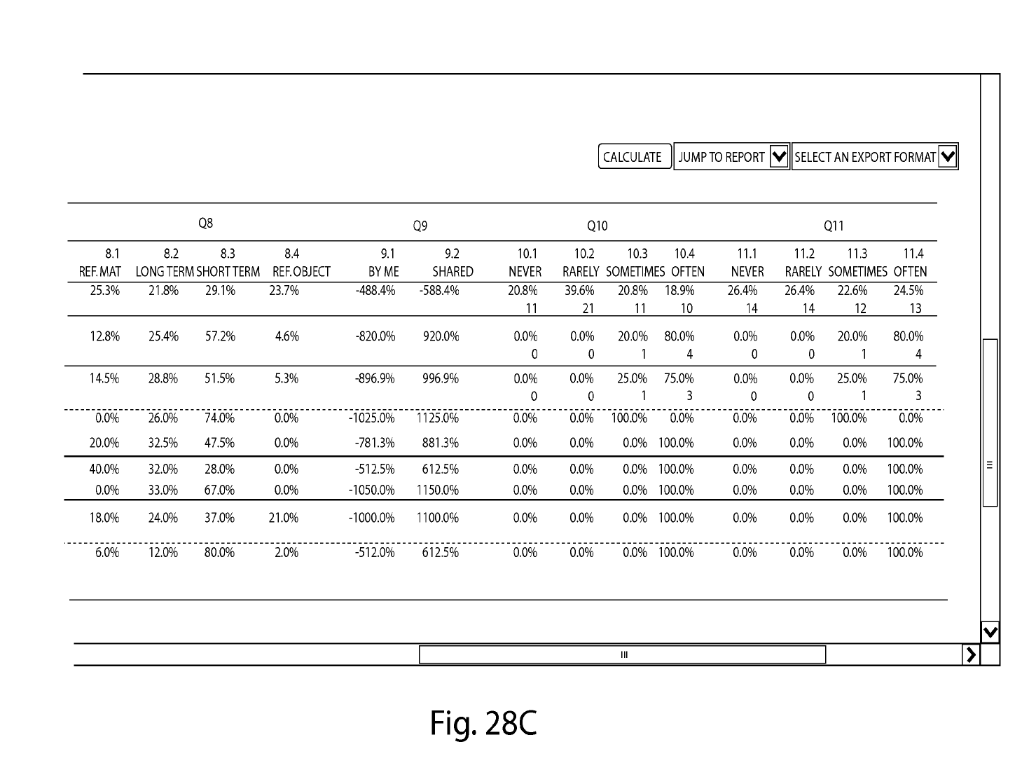

The Workstyles questions report simply shows the raw data for each question for the survey (this is preferably only used for internal purposes—such as validation or improvements in the system—and is not shared with a client organization with whom the system user administers such survey). The raw data for each question is shown in greater detail in FIGS. 28A-28C. FIGS. 28A-28C show the data for each of the questions Q1-Q11 with additional question Q12 also being displayable. The questions are shown in an expanded format after the plus button next to each question has been clicked to show the individual answers, such as answers 1.1 and 1.2 for question Q1. The data is then filtered by Department, Job type and Office type (as example filters set up above) and shows the actual number of survey respondents for each (n) and the percentage values. This provides an indication of how each of the individual answers was selected during the survey-taking step. Any question can be reduced when generating the report. In this manner, the columns can be expanded horizontally to include any selected column for any selected question Q1-Q12.

Finally, the Workstyles autoreport page, selected from the roll down menu (see FIG. 22B), generates an automated report where the system populates a report template with custom information for a specific company or organization based on collected data.

The above-described system and method of the invention provide an improved system for generating design guidelines and the specific design implications that may be associated with departments, groups, or subgroups forming an organization.

Although particular preferred embodiments of the invention have been disclosed in detail for illustrative purposes, it will be recognized that variations or modifications of the disclosed apparatus, including the rearrangement of parts, lie within the scope of the present invention.

1. A computer-based tool for designing workspaces of a plurality of individual employees working within an organization, the tool comprising:
a memory having a plurality of stored questions for assessing extrinsic and intrinsic work characteristics of each of the individual employees within the organization;
a user interface in communication with the memory, the user interface for implementing a survey for each of the individual employees, wherein the user interface is configured to selectively provide at least one of the stored questions from the memory to each of the individual employees, wherein the user interface is configured to obtain answers from each of the individual employees and output information relating to the extrinsic and intrinsic work characteristics of each of the individual employees;
a processor in communication with the user interface, the processor configured to:
receive the information from the user interface;
define at least one group formed of a subset of the individual employees working within the organization;
evaluate the information relating to extrinsic and intrinsic work characteristics for each of the at least one group; and
output one or more design implications for the workspaces based on the extrinsic and intrinsic work characteristics for each of the at least one group; and
a design implications interface in communication with the processor, the design implications interface configured to receive the one or more design implications from the processor and configured to display the one or more design implications.

2. The computer-based tool of claim 1 wherein the processor is programmed to define a set of workstyles, the workstyles being based on extrinsic and intrinsic work characteristics of people; wherein the evaluation of the information includes determining one or more dominant workstyles exhibited by each defined group; and wherein the design implications are based on the one or more dominant workstyles.

3. The computer-based tool of claim 2 wherein the set of workstyles is based on four domains, wherein the four domains are identified as a people domain, a place domain, a knowledge domain, and a control domain, and wherein each of the four domains has two opposing poles.

4. The computer-based tool of claim 3 wherein the set of workstyles includes eleven sets, the eleven sets comprising (a) eight sets based on the place domain having its pole in a fixed state and combinations of the other three domains and their associated poles and (b) three sets based on the place domain having its pole in a mobile state, wherein the three sets are defined as internal mobile, external mobile, and home based, and wherein the other three domains and their associated poles are irrelevant when the place domain has its pole in a mobile state.

5. The computer-based tool of claim 2 wherein the evaluation of information includes identifying a single workstyle associated with each of the individual employees or a subgroup of the individual employees.

6. The computer-based tool of claim 2 wherein a confidentiality threshold prevents identification of the assessed extrinsic and intrinsic work characteristics of specific individual employees within the organization.

7. The computer-based tool of claim 1 wherein the at least one group includes at least one pre-defined group based on at least one of age, gender, job level, and job type.

8. The computer-based tool of claim 1 wherein the processor is programmed to redefine the at least one group and re-evaluate the information relating to extrinsic and intrinsic work characteristics of the plurality of individual employees for the redefined at least one group.

9. The computer-based tool of claim 1 wherein the memory includes secondary questions directed toward supplementary work characteristics, wherein the one or more design implications for the workspaces are based in part on the answers to the secondary questions.

10. The computer-based tool of claim 1 wherein the one or more design implications include at least eight categories relating to a plurality of workspaces features, wherein the eight categories include layout, enclosure, workspace area, desk surface, task chair, individual storage, task lighting, and team storage.

11. The computer-based tool of claim 1 wherein the design interface outputs a weighted importance for at least one of the one or more design implications depending on a number of individuals within each group to which a particular feature is important, wherein the weighted importance includes an indicator of a degree of confidence associated with the at least one of the one or more design implications.

12. The computer-based tool of claim 11 wherein the one or more design implications provide relative terms to be considered for planning the workspaces.

13. The computer-based tool of claim 11 wherein the one or more design implications include a visual indication of the degree of confidence associated the one or more design implications.

14. The computer-based tool of claim 1 wherein the user interface selectively provides the questions from memory in a random order.

15. The computer-based tool of claim 1 wherein the user interface displays a time for completing the survey, wherein the time is based on an average of measured times for completion of past survey takers.

16. The computer-based tool of claim 1 wherein the user interface is adapted to display a plurality of sliding scales, each of the plurality of sliding scales being user selectable to allocate points of a total points pool, wherein a combined points of the plurality of sliding scales is less than or equal to the total points pool.

17. The computer-based tool of claim 1 wherein the design implications interface outputs one or more design implications for each of the groups of individual employees within the organization.

18. The computer-based tool of claim 1 wherein the design implications interface is configured to aid development of a work station layout for each of the groups of individual employees within the organization based at least in part on the one or more design implications.

19. The computer-based tool of claim 1 wherein the memory is part of a remote server and the user interface is provided via a website.

20. A computer-based system for designing workspaces of a plurality of individual employees working within an organization, the system comprising:
at least one group formed of a subset of the individual employees working within the organization;
a survey tool for assessing extrinsic and intrinsic work characteristics of the plurality of individual employees within the organization; and
a processor programmed to:
evaluate survey data output from the survey tool such that the processor evaluates extrinsic and intrinsic work characteristics for each group of individual employees; and
display one or more design implications for the workspaces based on the evaluation of the extrinsic and intrinsic work characteristics for each group of individual employees.

21. The computer-based system of claim 20 wherein the processor is programmed to define a set of workstyles, the workstyles being based on extrinsic and intrinsic work characteristics of people; wherein the evaluation of the survey data includes determining one or more dominant workstyles exhibited by each defined group; and wherein the one or more design implications are based on the one or more dominant workstyles.

22. The computer-based system of claim 21 wherein the set of workstyles is based on four domains, wherein the four domains are identified as a people domain, a place domain, a knowledge domain, and a control domain, and wherein each of the four domains has two opposing poles.

23. The computer-based system of claim 22 wherein the set of workstyles includes eleven sets, the eleven sets comprising (a) eight sets based on the place domain having its pole in a fixed mobile state and combinations of the other three domains and their associated poles and (b) three sets based on the place domain having its pole in a mobile state, wherein the three sets are defined as internal mobile, external mobile, and home based, and wherein the other three domains and their associated poles are irrelevant when the place domain has its pole in a mobile state.

24. The computer-based system of claim 21 wherein the evaluation of survey data includes identifying a single workstyle associated with each of the individual employees or a group of the individual employees.

25. The computer-based system of claim 21 wherein a confidentiality threshold prevents identification of extrinsic and intrinsic work characteristics of specific individual employees within the organization.

26. The computer-based system of claim 20 wherein the at least one group includes a pre-defined group based on at least one of age, gender, job level, and job type.

27. The computer-based system of claim 20 wherein the processor is programmed to redefine the at least one group and re-evaluate the survey data to evaluate extrinsic and intrinsic work characteristics of the plurality of individual employees for the redefined at least one group.

28. The computer-based system of claim 20 wherein the survey tool provides secondary questions to the plurality of individual employees, the secondary questions being directed toward supplementary work characteristics, wherein the one or more design implications for the workspaces are based in part on the answers to the secondary questions.

29. The computer-based system of claim 20 wherein the one or more design implications include at least eight categories relating to a plurality of workspace features, wherein the eight categories includes layout, enclosure, workspace area, desk surface, task chair, individual storage, task lighting, and team storage.

30. The computer-based system of claim 20 wherein the processor is programmed to display a weighted importance for at least one of the one or more design implications depending on a number of individuals within each group to which a particular feature is important, wherein the weighted importance includes an indicator of a degree of confidence associated with the at least one of the one or more design implications.

31. The computer-based system of claim 30 wherein the one or more design implications provide relative terms to be considered for planning the workspaces.

32. The computer-based system of claim 30 wherein the one or more design implications include a visual indication of the degree of confidence associated the one or more design implications.

33. The computer-based system of claim 20 wherein the survey tool selectively provides questions in a random order.

34. The computer-based system of claim 20 wherein the survey tool displays a time for completion, wherein the time is based on an average of measured times for completion of past survey takers.

35. The computer-based system of claim 20 wherein the survey tool is adapted to display a plurality of sliding scales, each of the plurality of sliding scales being user selectable to allocate points of a total points pool, wherein a combined points of the plurality of sliding scales is less than or equal to the total points pool.

36. The computer-based system of claim 20 wherein the processor is programmed to output one or more design implications for each of the groups of individual employees within the organization.

37. The computer-based system of claim 20 wherein the processor is programmed to develop a work station design implication for each of the groups of individual employees within the organization.

38. A method for designing workspaces of a plurality of individual employees working within an organization, the method comprising:
providing at least one group formed of a subset of the individual employees working within the organization;
using a computer-based survey tool for assessing extrinsic and intrinsic work characteristics of each of the individual employees within the organization;
evaluating the assessed extrinsic and intrinsic work characteristics of the plurality of individual employees for each group; and
based on said evaluating for each group, producing one or more design implications for the workspaces.

39. The method of claim 38 further comprising:
providing a set of workstyles, the workstyles being based on extrinsic and intrinsic work characteristics of people;
wherein said evaluating includes determining one or more dominant workstyles exhibited by each group; and
wherein the one or more design implications are based on the one or more dominant workstyles.

40. The method of claim 39 wherein the set of workstyles is based on four domains, wherein the four domains are identified as a people domain, a place domain, a knowledge domain, and a control domain, and wherein each of the four domains has two opposing poles.

41. The method of claim 40 wherein the set of workstyles includes eleven sets, the eleven sets comprising (a) eight sets based on the place domain having its pole in a fixed state and combinations of the other three domains and (b) three sets based on the place domain having its pole in a mobile state, wherein the three states include internal mobile, external mobile, and home based.

42. The method of claim 39 wherein said assessing includes identifying a single workstyle associated with each of the individual employees or a group of the individual employees.

43. The method of claim 39 wherein a confidentiality threshold prevents identifying assessed extrinsic and intrinsic work characteristics of specific individual employees within the organization.

44. The method of claim 38 wherein the at least one group includes a pre-defined group based on at least one of age, gender, job level, and job type.

45. The method of claim 38 further comprising redefining said at least one group and re-evaluating the assessed extrinsic and intrinsic work characteristics of the plurality of individual employees for the redefined at least one group.

46. The method of claim 38 wherein the computer-based survey tool includes secondary questions directed toward supplementary work characteristics, wherein the one or more design implications for the workspaces are based in part on the answers to the secondary questions.

47. The method of claim 38 wherein the one or more design implications include at least eight categories relating to a plurality of workspace features, wherein the eight categories include layout, enclosure, workspace area, desk surface, task chair, individual storage, task lighting, and team storage.

48. The method of claim 38 wherein said producing the one or more design implications includes providing a weighted importance for at least one of the one or more design implications depending on a number of individuals within each group to which a particular feature is important, wherein the weighted importance includes an indicator of a degree of confidence associated with the at least one of the one or more design implications.

49. The method of claim 48 wherein the one or more design implications provide relative terms to be considered for planning and designing individual workspaces.

50. The method of claim 48 wherein the one or more design implications include a visual indication of the degree of confidence associated with the at least one of the design implications.

51. The method of claim 38 wherein the computer-based survey tool includes a randomized set of questions.

52. The method of claim 38 wherein the computer-based survey tool displays a time for completion, wherein the time is based on an average of measured times for completion of past survey takers.

53. The method of claim 38 wherein the computer-based survey tool includes a display having a plurality of sliding scales, each of the plurality of sliding scales being user selectable to allocate points of a points pool, wherein a combined points of the plurality of sliding scales is less than or equal to the points pool.

54. The method of claim 38 wherein said producing the design implications includes providing one or more design implications for each of the groups of individual employees within the organization.

55. The method of claim 38 further comprising developing work station layouts for each of the groups of individual employees within the organization based at least in part on the one or more design implications.

56. A method for developing design implications for workspaces of a plurality of individual employees working within an organization, the method comprising:
providing a set of workstyles, the workstyles being based on extrinsic and intrinsic work characteristics of people, wherein the set of workstyles is based on four domains, wherein the four domains are identified as a people domain, a place domain, a knowledge domain, and a control domain, and wherein each of the four domains has two opposing poles;
providing a survey to each of the individual employees, the survey including a series of questions for assessing extrinsic and intrinsic work characteristics of each of the individual employees;
evaluating answers to each of the series of questions in the survey to determine a personal workstyle for each of the individual employees, the personal workstyle being selected from one of the set of workstyles.

57. The method of claim 56 wherein the set of workstyles includes eleven sets, the eleven sets comprising (a) eight sets based on the place domain having its pole in a fixed state and combinations of the other three domains and their associated poles and (b) three sets based on the place domain having its pole in a mobile state, wherein the three sets are defined as internal mobile, external mobile, and home based.
